(19) United States
(12) Patent Application Publication
(10) Pub. No.: US 2017/0305946 A1
(43) Pub. Date: Oct. 26, 2017

(54) COMPOSITIONS AND METHODS COMPRISING RHENIUM FOR THE TREATMENT OF CANCERS

(71) Applicant: Massachusetts Institute of Technology, Cambridge, MA (US)

(72) Inventors: Stephen J. Lippard, Cambridge, MA (US); Julia Elaine Page, Winchester, MA (US); Kogularamanan Suntharalingam, Boston, MA (US)

(73) Assignee: Massachusetts Institute of Technology, Cambridge, MA (US)

(21) Appl. No.: 15/424,710

(22) Filed: Feb. 3, 2017

Related U.S. Application Data
(63) Continuation of application No. 14/692,296, filed on Apr. 21, 2015, now abandoned.
(60) Provisional application No. 61/991,271, filed on May 9, 2014.
(60) Provisional application No. 61/982,075, filed on Apr. 21, 2014.

(51) Int. Cl. C07F 13/00

(52) U.S. Cl. CPC C07F 13/005

(57) ABSTRACT

Compositions and methods comprising rhenium are provided. In some embodiments, the rhenium compounds comprise a bidentate ligand. In some embodiments, the rhenium compounds are used in method for treating cancer.

### RELATED APPLICATIONS

This application claims priority under 35 U.S.C. §119(e) to U.S. provisional patent applications, U.S. Ser. No. 61/982,075, filed Apr. 21, 2014, entitled “RHENIUM(V)-OXO COMPLEXES: A NEW GENERATION OF POTENT ANTICANCER AGENTS,” by Stephen J. Lippard, et al., and U.S. Ser. No. 61/991,271, filed May 9, 2014, entitled “COMPOSITIONS AND METHODS COMPRISING RHENIUM FOR THE TREATMENT OF CANCERS,” by Stephen J. Lippard, et al., each of which is incorporated herein by reference.

### STATEMENT REGARDING FEDERALLY SPONSORED RESEARCH OR DEVELOPMENT

This invention was made with government support under Grant No. CA034992 awarded by the National Institutes of Health. The government has certain rights in the invention.

### TECHNICAL FIELD

Compositions and methods comprising rhenium are provided. In some embodiments, the rhenium compounds comprise a bidentate ligand. In some embodiments, the rhenium compounds are used in method for treating cancer.

### BACKGROUND

Platinum-based drugs are among the most active and widely used anticancer agents. Although platinum-based cancer chemotherapeutics are effective against a number of solid tumors, especially testicular and ovarian cancer, the clinical use of certain platinum-based cancer chemotherapeutics has been limited because of their toxic effects as well as the intrinsic and acquired resistance of some tumors to certain platinum-based cancer chemotherapeutics drug. Drawbacks associated with platinum therapy, such as acquired or inherent resistance, toxic side effects, and tumor recurrence after initial treatment, have prompted researchers to investigate alternative transition metal-based anticancer drugs. Accordingly, improved compositions and methods are needed.

### SUMMARY

The subject matter of the present invention involves, in some cases, interrelated products, alternative solutions to a particular problem, and/or a plurality of different uses of one or more systems and/or articles.

In some embodiments, a compound comprising Formula (I) is provided:

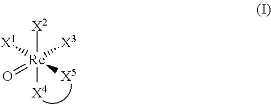

wherein:

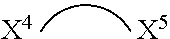

is a bidentate ligand and X⁴ and X⁵ are the same or different and are selected from the group consisting of N, O, S, and P;

X¹, X², and X³ are the same or different and are selected from the group consisting of optionally substituted alkyl, optionally substituted heteroalkyl, halo, —CN, —OR′, —SR′, —SCN, —OCOR′, —OSO₂, and —OPO₃R′₂; and

each R′ is independently hydrogen, optionally substituted alkyl, optionally substituted heteroalkyl, optionally substituted aryl, or optional substituted heteroaryl.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

FIGS. 1A-1B: show (A) IC₅₀ values (in μM) of non-limiting rhenium compounds, etoposide, and cisplatin against A549 cells in the absence and presence of apoptosis inhibitor, z-VAD-FMK (5 μM), after 72 h incubation; and (B) IC₅₀ values (in μM) of non-limiting rhenium compounds against A549 cells in the absence and presence of H₂O₂-induced necrosis inhibitor, IM-54 (10 μM), and necroptosis inhibitor, necrostatin-1 (60 μM), after 72 h incubation, according to some embodiments.

FIGS. 2A-2D show representative histograms displaying the green fluorescence emitted by various cell types treated with with non-limiting rhenium compounds, according to some embodiments.

FIGS. 3A-3B show IC₅₀ values (in μM) of non-limiting rhenium compounds against various cell types, according to some embodiments.

### DETAILED DESCRIPTION

Compositions and methods comprising rhenium are provided. In some embodiments, the rhenium compounds comprise a bidentate ligand. In some embodiments, the rhenium compounds are used in method for treating cancer. The subject matter of the present invention involves, in some cases, interrelated products, alternative solutions to a particular problem, and/or a plurality of different uses of one or more systems and/or articles.

In some aspects, the disclosure provides compounds and related compositions for use in treating subjects known to have (e.g., diagnosed with) cancer or subjects at risk of developing cancer. In some embodiments, methods of the invention include administering to a subject a therapeutically effective amount of a compound, or a therapeutic preparation, composition, or formulation of the compound as described herein, to a subject having or suspected of having a cancer.

In some embodiments, the rhenium compound is a rhenium-oxo compound. In some embodiments, a rhenium-oxo compound is associated with a bidentate ligand, and one or more other ligands. As will be known to those of ordinary skill in the art, a bidentate ligand, when bound to a metal center, forms a metallacycle structure with the metal center, also known as a chelate ring. Bidentate ligands suitable for use in the present invention include species that have at least two sites capable of binding to a metal center. For example, the bidentate ligand may comprise at least two heteroatoms that coordinate the metal center, or a heteroatom and an anionic carbon atom that coordinate the metal center. Examples of bidentate ligands suitable for use in the invention include, but are not limited to, alkyl and aryl derivatives of moieties such as amines, phosphines, phosphites, phosphates, imines, oximes, ethers, thiolates, thioethers, hybrids thereof, substituted derivatives thereof, aryl groups (e.g., bis-aryl, heteroaryl-substituted aryl), heteroaryl groups, and the like. Specific examples of bidentate ligands include ethylenediamine, 2,2′-bipyridine, acetylacetonate, oxalate, and the like. Other non-limiting examples of bidentate ligands include diimines, pyridylimines, diamines, imineamines, iminethioether, iminephosphines, bisoxazoline, bisphosphineimines, diphosphines, phosphineamine, salen and other alkoxy imine ligands, amidoamines, imidothioether fragments and alkoxyamide fragments, and combinations of the above ligands.

In some embodiments, a rhenium compound comprises Formula (I):

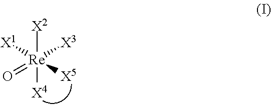

wherein:

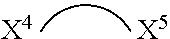

is a bidentate ligand and X⁴ and X⁵ are the same or different and are selected from the group consisting of N, O, S, and P;
X¹, X², and X³ are the same or different and are selected from the group consisting of optionally substituted alkyl, optionally substituted heteroalkyl, halo, —CN, —OR′, —SR′, —SCN, —OCOR′, —OSO₂, and —OPO₃R′₂; and
each R′ is independently hydrogen, optionally substituted alkyl, optionally substituted heteroalkyl, optionally substituted aryl, or optional substituted heteroaryl.

It should be understood that the rhenium compounds described herein may also be provide as homologs, analogs, derivatives, enantiomers, diastereomers, tautomers, cis- and trans-isomers, and functionally equivalent compositions of compounds described herein. “Functionally equivalent” generally refers to a composition capable of treatment of patients having cancer, or of patients susceptible to cancers. For example, the rhenium-oxo compounds described may comprise one or more of the following structures:

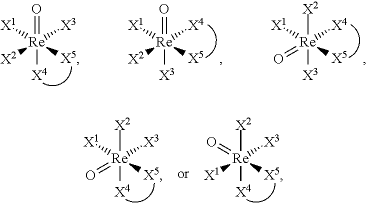

wherein X¹-X⁵ are as described herein. In some embodiments, the oxo ligand is in an axial position. In some embodiments, the oxo ligand is in an equatorial position. In some embodiments, both binding sites of the bidentate ligand are in an equatorial position. In some embodiments, one binding site of the bidentate ligand is in an axial position and the other binding site of the bidentate ligand is in an equatorial position. In some embodiments, the oxo ligand is trans to one binding site of the bidentate ligand and equatorial to the second binding site of the bidentate ligand. In some embodiments, the oxo ligand is cis to both binding site of the bidentate ligand. In a particular embodiment, the rhenium compound has the structure:

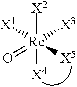

It will be understood that the skilled artisan will be able to manipulate the conditions in a manner to prepare such homologs, analogs, derivatives, enantiomers, diastereomers, tautomers, cis- and trans-isomers, and functionally equivalent compositions. Homologs, analogs, derivatives, enantiomers, diastereomers, tautomers, cis- and trans-isomers, and functionally equivalent compositions which are about as effective or more effective than the parent compound are also intended for use in the method of the invention. Such compositions may also be screened by the assays described herein for increased potency and specificity towards a cancer, preferably with limited side effects. Synthesis of such compositions may be accomplished through typical chemical modification methods such as those routinely practiced in the art. Another aspect of the present invention provides any of the above-mentioned compounds as being useful for the treatment of cancer.

In some embodiments, for a compound of Formula (I) (or an isomer thereof), X⁴ and X⁵ are N. In some embodiments, X⁴ and X⁵ are O. In some embodiments, X⁴ and X⁵ are S. In some embodiments, X⁴ and X⁵ are P.

In some embodiments,

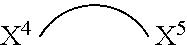

comprises the structure:

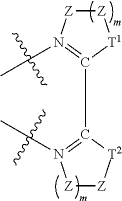

wherein:
each Z is independently —NR″—, —CR″═, —CR″₂—, —O—, or —S—;
T¹ and T² are independently —NR″—, —CR″═, —CR″₂—, —O—, or —S—, or optionally, T¹ and T² may be joined together to form a ring;
each R″ is independently hydrogen, optionally substituted alkyl, optionally substituted heteroalkyl, optionally substituted alkenyl, optionally substituted alkynyl, optionally substituted aryl, or optionally substituted heteroaryl, or optionally, any two R″ may be joined to form a ring; and
each m is independently 1 or 2. In some embodiments, each m is 1. In some embodiments, each m is 2. In some embodiments, one m is 1 and the other m is 2.

In some embodiments, wherein X⁴ and X⁵ are N,

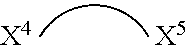

comprises the structure:

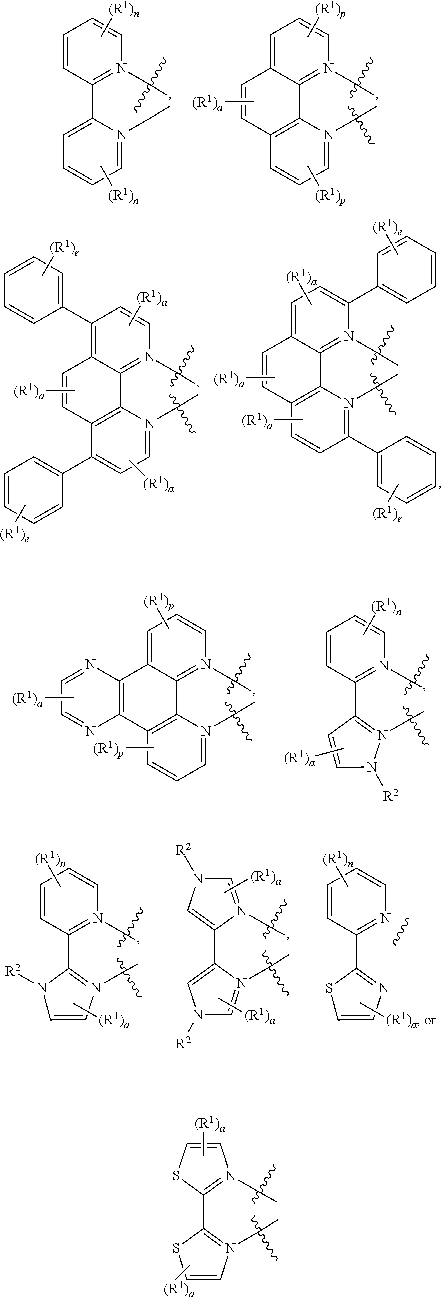

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl, or optionally any two R¹ may be joined to form a ring;

each R² is independently hydrogen, optionally substituted alkyl, optionally substituted heteroalkyl, optionally substituted aryl, optional substituted heteroaryl, or optionally substituted alkoxy;

each R³ is independently hydrogen, optionally substituted alkyl, optionally substituted heteroalkyl, optionally substituted aryl, or optional substituted heteroaryl;

each e is independently 0, 1, 2, 3, 4, or 5;

each n is independently 0, 1, 2, 3, or 4;

each p is independently 0, 1, 2, or 3; and

each a is independently 0, 1, or 2. In some embodiments, each e, n, p, and a is 0.

In some embodiments, for a compound of Formula (I) (or an isomer thereof), X⁴ and X⁵ are N and

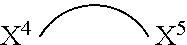

comprises the structure:

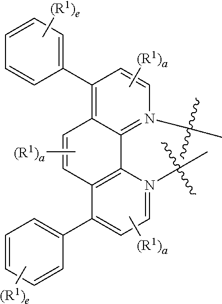

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl;

each R³ is independently hydrogen, optionally substituted alkyl, optionally substituted heteroalkyl, optionally substituted aryl, or optional substituted heteroaryl;

each e is independently 0, 1, 2, 3, 4, or 5; and

each a is independently 0, 1, or 2. In some embodiments, each e is 0. In some embodiments, each a is 0. In some embodiments, each of e and a is 0.

In some embodiments, for a compound of Formula (I) (or an isomer thereof), X⁴ and X⁵ are N and

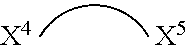

comprises the structure:

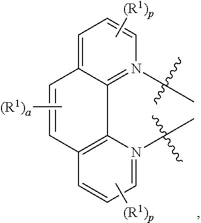

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl;

each R³ is independently hydrogen, optionally substituted alkyl, optionally substituted heteroalkyl, optionally substituted aryl, or optional substituted heteroaryl;

each a is independently 0, 1, or 2; and

each p is independently 0, 1, 2, or 3. In some embodiments, each p is 0. In some embodiments, each a is 0. In some embodiments, each of p and a is 0. In some embodiment, each p is 2, a is 0, and each R¹ is alkyl, optionally substituted. In some embodiments,

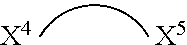

comprises the structure:

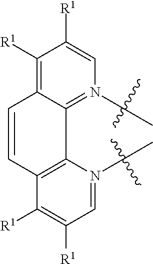

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl; and

each R³ is independently hydrogen, optionally substituted alkyl, optionally substituted heteroalkyl, optionally substituted aryl, or optional substituted heteroaryl. In some embodiments, each R¹ is optionally substituted alkyl. In some embodiments, each R¹ is methyl.

In some embodiments, for a compound of Formula (I) (or an isomer thereof), X¹, X², and X³ are the same or different and are selected from the group consisting of optionally substituted alkyl, optionally substituted heteroalkyl, halo, —CN, —OR′, —SR′, —SCN, —OCOR′, —OSO₂, and —OPO₃R′₂; and each R′ is independently hydrogen, optionally substituted alkyl, optionally substituted heteroalkyl, optionally substituted aryl, or optional substituted heteroaryl. In some embodiments, X¹ and X² are halo. In some embodiments, X¹ and X² are chloro. In some embodiments, X³ is OR′. In some embodiments, X³ is OR′, and R′ is optionally substituted alkyl.

In some embodiments, the compound of Formula (I) comprises Formula (II):

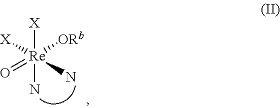

wherein:

each X is the same or different and is halo;

R^{b} is optionally substituted alkyl, optionally substituted heteroalkyl, optionally substituted aryl, or optional substituted heteroaryl; and

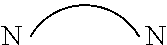

is a bidentate ligand as described herein. In some embodiments, each X is chloro. In some embodiments R^{b} is optionally substituted alkyl. In some embodiments R^{b} is methyl.

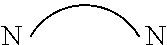

In some embodiments for a compound for Formula (II), comprises the structure:

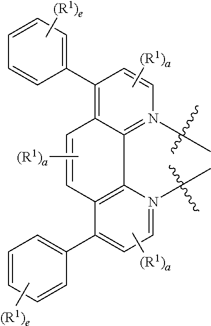

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl;

each R³ is independently hydrogen, optionally substituted alkyl, optionally substituted heteroalkyl, optionally substituted aryl, or optional substituted heteroaryl;

each e is independently 0, 1, 2, 3, 4, or 5; and

each a is independently 0, 1, or 2. In some embodiments, each e is 0. In some embodiments, each a is 0. In some embodiments, each of e and a is 0.

In some embodiments for a compound for Formula (II),

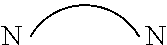

comprises the structure:

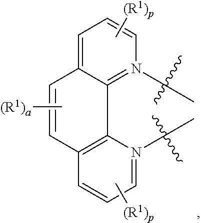

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl;

each R³ is independently hydrogen, optionally substituted alkyl, optionally substituted heteroalkyl, optionally substituted aryl, or optional substituted heteroaryl;

each a is independently 0, 1, or 2; and

each p is independently 0, 1, 2, or 3. In some embodiments, each p is 0. In some embodiments, each a is 0. In some embodiments, each of p and a is 0.

In some embodiments, for a compound of Formula (II),

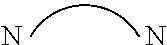

comprises the structure:

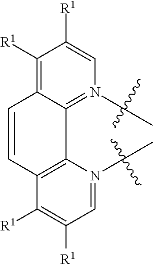

wherein:

each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl; and each R³ is independently hydrogen, optionally substituted alkyl, optionally substituted heteroalkyl, optionally substituted aryl, or optional substituted heteroaryl. In some cases, each R¹ is optionally substituted alkyl. In some cases, each R¹ is methyl.

In some embodiments, a compound of Formula (I) has the structure:

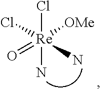

wherein

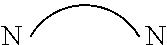

comprises a bidentate ligand as described herein.
In a particular embodiment, a compound of Formula (I) has the structure:

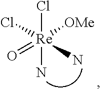

wherein

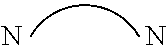

comprises the structure

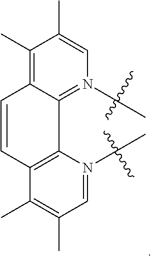

In another particular embodiment, a compound of Formula (I) has the structure:

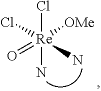

wherein

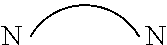

comprises the structure

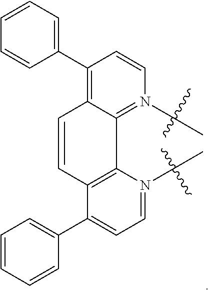

Rhenium compounds may be synthesized according to methods known in the art, including various methods described herein. For example, the method may comprise reaction of a rhenium oxo precursor compound (e.g., Re(═O)X₃(PR^{a}₃)₂, wherein X is a halide (e.g., Cl) and each R^{a} is the same or different and is optionally substituted alkyl, optionally substituted heteroalkyl, optionally substituted aryl, or optionally substituted heteroaryl (e.g., PPh₃) with a bidentate ligand.

In some embodiments, method for treating a subject having a cancer are provided, wherein the method comprises administering a therapeutically-effective amount of a compound, as described herein, to a subject having a cancer or suspected of having cancer. In some cases, the subject may be otherwise free of indications for treatment with said compound. In some cases, methods include use of cancer cells, including but not limited to mammalian cancer cells. In some instances, the mammalian cancer cells are human cancer cells. In some embodiments, the compounds and methods described herein are useful for treating cells which are resistant to other cancer treatment agents (e.g., cis-platinum). Without wishing to be bound by theory, this may be due, in part, to a different mechanism of action of the compounds described herein as compared to common cancer treatment agents. In some embodiments, the compounds described herein have a mechanism of action comprising necroptosis, an ordered form of necrosis. In some embodiments, the compounds described herein have a mechanism of action comprising necrosis.

In some embodiments, the compounds of the invention possess one or more desirable, but unexpected, combinations of properties, including increased activity and/or cytotoxicity, and reduction of adverse side effects. These compounds have been found to inhibit cancer growth, including proliferation, invasiveness, and metastasis, thereby rendering them particularly desirable for the treatment of cancer.

In some embodiments, the compounds as described herein have substantially high cytotoxicities. In some cases, the IC₅₀ for a compound of the present invention is less than about 2 uM (micromolar), less than about 1.5 uM, less than about 1.0 uM, less than about 0.9 uM, less than about 0.8 uM, less than about 0.7 uM, less than about 0.6 uM, less than about 0.5 uM, less than about 0.4 uM, less than about 0.3 uM, less than about 0.2 uM, less than about 0.1 uM, or less.

In some embodiments, the compounds of the present invention may be used to prevent the growth of a tumor or cancer, and/or to prevent the metastasis of a tumor or cancer. In some embodiments, compositions of the invention may be used to shrink or destroy a cancer. It should be appreciated that compositions of the invention may be used alone or in combination with one or more additional anti-cancer agents or treatments (e.g., chemotherapeutic agents, targeted therapeutic agents, pseudo-targeted therapeutic agents, hormones, radiation, surgery, etc., or any combination of two or more thereof). In some embodiments, a composition of the invention may be administered to a patient who has undergone a treatment involving surgery, radiation, and/or chemotherapy. In certain embodiments, a composition of the invention may be administered chronically to prevent, or reduce the risk of, a cancer recurrence.

The cancers treatable by methods of the present invention preferably occur in mammals. Mammals include, for example, humans and other primates, as well as pet or companion animals, such as dogs and cats, laboratory animals, such as rats, mice and rabbits, and farm animals, such as horses, pigs, sheep, and cattle. In some embodiments, the compounds of the present invention may be used to treat or affect cancers including, but not limited to lymphatic metastases, squamous cell carcinoma, particularly of the head and neck, esophageal squamous cell carcinoma, oral carcinoma, blood cell malignancies, including multiple myeloma, leukemias, including acute lymphocytic leukemia, acute nonlymphocytic leukemia, chronic lymphocytic leukemia, chronic myelocytic leukemia, and hairy cell leukemia, effusion lymphomas (body cavity based lymphomas), thymic lymphoma lung cancer, including small cell carcinoma, cutaneous T cell lymphoma, Hodgkin's lymphoma, non-Hodgkin's lymphoma, cancer of the adrenal cortex, ACTH-producing tumors, nonsmall cell cancers, breast cancer, including small cell carcinoma and ductal carcinoma, gastrointestinal cancers, including stomach cancer, colon cancer, colorectal cancer, polyps associated with colorectal neoplasia, pancreatic cancer, liver cancer, urological cancers, including bladder cancer, including primary superficial bladder tumors, invasive transitional cell carcinoma of the bladder, and muscle-invasive bladder cancer, prostate cancer, malignancies of the female genital tract, including ovarian carcinoma, primary peritoneal epithelial neoplasms, cervical carcinoma, uterine endometrial cancers, vaginal cancer, cancer of the vulva, uterine cancer and solid tumors in the ovarian follicle, malignancies of the male genital tract, including testicular cancer and penile cancer, kidney cancer, including renal cell carcinoma, brain cancer, including intrinsic brain tumors, neuroblastoma, astrocytic brain tumors, gliomas, metastatic tumor cell invasion in the central nervous system, bone cancers, including osteomas and osteosarcomas, skin cancers, including malignant melanoma, tumor progression of human skin keratinocytes, squamous cell cancer, thyroid cancer, retinoblastoma, neuroblastoma, peritoneal effusion, malignant pleural effusion, mesothelioma, gall bladder cancer, trophoblastic neoplasms, and hemangiopericytoma. In some cases, the cancer is lung, ovarian, cervix, breast, bone, colorectal, and/or prostate cancer. In some cases, the cancer is lung cancer. In some cases, the cancer is human lung carcinoma and/or normal lung fibroblast.

The invention further comprises compositions (including pharmaceutical compositions), preparations, formulations, kits, and the like, comprising any of the compounds as described herein. In some cases, a pharmaceutical composition is provided comprising a composition as described herein, or a pharmaceutically acceptable salt thereof, and one or more pharmaceutically acceptable carriers, additives and/or diluents. In some cases, a kit (e.g., for the treatment of cancer) comprises a composition (or a pharmaceutical composition) as described herein and instructions for use of the composition (or a pharmaceutical composition) for treatment of cancer. These and other embodiments of the invention may also involve promotion of the treatment of cancer or tumor according to any of the techniques and compositions and combinations of compositions described herein.

In some embodiments, the present invention provides “pharmaceutical compositions” or “pharmaceutically acceptable” compositions, which comprise a therapeutically effective amount of one or more of the compounds described herein, formulated together with one or more pharmaceutically acceptable carriers (additives) and/or diluents. The pharmaceutical compositions of the present invention may be specially formulated for administration in solid or liquid form, including those adapted for the following: oral administration, for example, drenches (aqueous or non-aqueous solutions or suspensions), tablets, e.g., those targeted for buccal, sublingual, and systemic absorption, boluses, powders, granules, pastes for application to the tongue; parenteral administration, for example, by subcutaneous, intramuscular, intravenous or epidural injection as, for example, a sterile solution or suspension, or sustained-release formulation; topical application, for example, as a cream, ointment, or a controlled-release patch or spray applied to the skin, lungs, or oral cavity; intravaginally or intrarectally, for example, as a pessary, cream or foam; sublingually; ocularly; transdermally; or nasally, pulmonary and to other mucosal surfaces.

The phrase “pharmaceutically acceptable” is employed herein to refer to those compounds, materials, compositions, and/or dosage forms which are, within the scope of sound medical judgment, suitable for use in contact with the tissues of human beings and animals without excessive toxicity, irritation, allergic response, or other problem or complication, commensurate with a reasonable benefit/risk ratio.

The phrase “pharmaceutically-acceptable carrier” as used herein means a pharmaceutically-acceptable material, composition or vehicle, such as a liquid or solid filler, diluent, excipient, or solvent encapsulating material, involved in carrying or transporting the subject compound from one organ, or portion of the body, to another organ, or portion of the body. Each carrier must be “acceptable” in the sense of being compatible with the other ingredients of the formulation and not injurious to the patient. Some examples of materials which can serve as pharmaceutically-acceptable carriers include: sugars, such as lactose, glucose and sucrose; starches, such as corn starch and potato starch; cellulose, and its derivatives, such as sodium carboxymethyl cellulose, ethyl cellulose and cellulose acetate; powdered tragacanth; malt; gelatin; talc; excipients, such as cocoa butter and suppository waxes; oils, such as peanut oil, cottonseed oil, safflower oil, sesame oil, olive oil, corn oil and soybean oil; glycols, such as propylene glycol; polyols, such as glycerin, sorbitol, mannitol and polyethylene glycol; esters, such as ethyl oleate and ethyl laurate; agar; buffering agents, such as magnesium hydroxide and aluminum hydroxide; alginic acid; pyrogen-free water; isotonic saline; Ringer's solution; ethyl alcohol; pH buffered solutions; polyesters, polycarbonates and/or polyanhydrides; and other non-toxic compatible substances employed in pharmaceutical formulations.

As set out herein, certain embodiments of the present compounds may contain be formed or provided as a salt, and in some cases, as a pharmaceutically acceptable salt. The term “pharmaceutically-acceptable salt” in this respect refers to the relatively non-toxic, inorganic and organic salts of compounds of the present invention. These salts can be prepared in situ in the administration vehicle or the dosage form manufacturing process, or by separately reacting a purified compound of the invention followed by reaction with a suitable reactant (e.g., suitable organic or inorganic acid and/or base), and isolating the salt thus formed during subsequent purification. Representative salts include the hydrobromide, hydrochloride, sulfate, bisulfate, phosphate, nitrate, acetate, valerate, oleate, palmitate, stearate, laurate, benzoate, lactate, phosphate, tosylate, citrate, maleate, fumarate, succinate, tartrate, napthylate, mesylate, glucoheptonate, lactobionate, and laurylsulphonate salts and the like. (See, for example, Berge et al., “Pharmaceutical Salts,” J. Pharm. Sci. 1977, 66, 1-19)

The pharmaceutically acceptable salts of the subject compounds include the conventional nontoxic salts or quaternary ammonium salts of the compounds, e.g., from non-toxic organic or inorganic acids. For example, such conventional nontoxic salts include those derived from inorganic acids such as hydrochloride, hydrobromic, sulfuric, sulfamic, phosphoric, nitric, and the like; and the salts prepared from organic acids such as acetic, propionic, succinic, glycolic, stearic, lactic, malic, tartaric, citric, ascorbic, palmitic, maleic, hydroxymaleic, phenylacetic, glutamic, benzoic, salicyclic, sulfanilic, 2-acetoxybenzoic, fumaric, toluenesulfonic, methanesulfonic, ethane disulfonic, oxalic, isothionic, and the like.

Wetting agents, emulsifiers and lubricants, such as sodium lauryl sulfate and magnesium stearate, as well as coloring agents, release agents, coating agents, sweetening, flavoring and perfuming agents, preservatives and antioxidants can also be present in the compositions.

Examples of pharmaceutically-acceptable antioxidants include: water soluble antioxidants, such as ascorbic acid, cysteine hydrochloride, sodium bisulfate, sodium metabisulfite, sodium sulfite and the like; oil-soluble antioxidants, such as ascorbyl palmitate, butylated hydroxyanisole (BHA), butylated hydroxytoluene (BHT), lecithin, propyl gallate, alpha-tocopherol, and the like; and metal chelating agents, such as citric acid, ethylenediamine tetraacetic acid (EDTA), sorbitol, tartaric acid, phosphoric acid, and the like.

The compound may be orally administered, parenterally administered, subcutaneously administered, and/or intravenously administered. In certain embodiments, a compound or pharmaceutical preparation is administered orally. In other embodiments, the compound or pharmaceutical preparation is administered intravenously. Alternative routes of administration include sublingual, intramuscular, and transdermal administrations.

Formulations of the present invention include those suitable for oral, nasal, topical (including buccal and sublingual), rectal, vaginal and/or parenteral administration. The formulations may conveniently be presented in unit dosage form and may be prepared by any methods well known in the art of pharmacy. The amount of active ingredient that can be combined with a carrier material to produce a single dosage form will vary depending upon the host being treated, and the particular mode of administration. The amount of active ingredient that can be combined with a carrier material to produce a single dosage form will generally be that amount of the compound which produces a therapeutic effect. Generally, this amount will range from about 1% to about 99% of active ingredient, from about 5% to about 70%, or from about 10% to about 30%.

In certain embodiments, a formulation of the present invention comprises an excipient selected from the group consisting of cyclodextrins, liposomes, micelle forming agents, e.g., bile acids, and polymeric carriers, e.g., polyesters and polyanhydrides; and a compound of the present invention. In certain embodiments, an aforementioned formulation renders orally bioavailable a compound of the present invention.

Methods of preparing these formulations or compositions include the step of bringing into association a compound of the present invention with the carrier and, optionally, one or more accessory ingredients. In general, the formulations are prepared by uniformly and intimately bringing into association a compound of the present invention with liquid carriers, or finely divided solid carriers, or both, and then, if necessary, shaping the product.

Formulations of the invention suitable for oral administration may be in the form of capsules, cachets, pills, tablets, lozenges (using a flavored basis, usually sucrose and acacia or tragacanth), powders, granules, or as a solution or a suspension in an aqueous or non-aqueous liquid, or as an oil-in-water or water-in-oil liquid emulsion, or as an elixir or syrup, or as pastilles (using an inert base, such as gelatin and glycerin, or sucrose and acacia) and/or as mouth washes and the like, each containing a predetermined amount of a compound of the present invention as an active ingredient. A compound of the present invention may also be administered as a bolus, electuary, or paste.

In solid dosage forms of the invention for oral administration (capsules, tablets, pills, dragees, powders, granules and the like), the active ingredient is mixed with one or more pharmaceutically-acceptable carriers, such as sodium citrate or dicalcium phosphate, and/or any of the following: fillers or extenders, such as starches, lactose, sucrose, glucose, mannitol, and/or silicic acid; binders, such as, for example, carboxymethylcellulose, alginates, gelatin, polyvinyl pyrrolidone, sucrose and/or acacia; humectants, such as glycerol; disintegrating agents, such as agar-agar, calcium carbonate, potato or tapioca starch, alginic acid, certain silicates, and sodium carbonate; solution retarding agents, such as paraffin; absorption accelerators, such as quaternary ammonium compounds; wetting agents, such as, for example, cetyl alcohol, glycerol monostearate, and non-ionic surfactants; absorbents, such as kaolin and bentonite clay; lubricants, such as talc, calcium stearate, magnesium stearate, solid polyethylene glycols, sodium lauryl sulfate, and mixtures thereof; and coloring agents. In the case of capsules, tablets and pills, the pharmaceutical compositions may also comprise buffering agents. Solid compositions of a similar type may also be employed as fillers in soft and hard-shelled gelatin capsules using such excipients as lactose or milk sugars, as well as high molecular weight polyethylene glycols and the like.

A tablet may be made by compression or molding, optionally with one or more accessory ingredients. Compressed tablets may be prepared using binder (for example, gelatin or hydroxypropylmethyl cellulose), lubricant, inert diluent, preservative, disintegrant (for example, sodium starch glycolate or cross-linked sodium carboxymethyl cellulose), surface-active or dispersing agent. Molded tablets may be made in a suitable machine in which a mixture of the powdered compound is moistened with an inert liquid diluent.

The tablets, and other solid dosage forms of the pharmaceutical compositions of the present invention, such as dragees, capsules, pills and granules, may optionally be scored or prepared with coatings and shells, such as enteric coatings and other coatings well known in the pharmaceutical-formulating art. They may also be formulated so as to provide slow or controlled release of the active ingredient therein using, for example, hydroxypropylmethyl cellulose in varying proportions to provide the desired release profile, other polymer matrices, liposomes, and/or microspheres. They may be formulated for rapid release, e.g., freeze-dried. They may be sterilized by, for example, filtration through a bacteria-retaining filter, or by incorporating sterilizing agents in the form of sterile solid compositions that can be dissolved in sterile water, or some other sterile injectable medium immediately before use. These compositions may also optionally contain opacifying agents and may be of a composition that they release the active ingredient(s) only, or in a certain portion of the gastrointestinal tract, optionally, in a delayed manner. Examples of embedding compositions that can be used include polymeric substances and waxes. The active ingredient can also be in micro-encapsulated form, if appropriate, with one or more of the above-described excipients.

Liquid dosage forms for oral administration of the compounds of the invention include pharmaceutically acceptable emulsions, microemulsions, solutions, suspensions, syrups, and elixirs. In addition to the active ingredient, the liquid dosage forms may contain inert diluents commonly used in the art, such as, for example, water or other solvents, solubilizing agents and emulsifiers, such as ethyl alcohol, isopropyl alcohol, ethyl carbonate, ethyl acetate, benzyl alcohol, benzyl benzoate, propylene glycol, 1,3-butylene glycol, oils (in particular, cottonseed, groundnut, corn, germ, olive, castor and sesame oils), glycerol, tetrahydrofuryl alcohol, polyethylene glycols and fatty acid esters of sorbitan, and mixtures thereof.

Besides inert diluents, the oral compositions can also include adjuvants such as wetting agents, emulsifying and suspending agents, sweetening, flavoring, coloring, perfuming, and preservative agents.

Suspensions, in addition to the active compounds, may contain suspending agents as, for example, ethoxylated isostearyl alcohols, polyoxyethylene sorbitol and sorbitan esters, microcrystalline cellulose, aluminum metahydroxide, bentonite, agar-agar and tragacanth, and mixtures thereof.

Formulations of the pharmaceutical compositions of the invention for rectal or vaginal administration may be presented as a suppository, which may be prepared by mixing one or more compounds of the invention with one or more suitable nonirritating excipients or carriers comprising, for example, cocoa butter, polyethylene glycol, a suppository wax or a salicylate, and which is solid at room temperature, but liquid at body temperature and, therefore, will melt in the rectum or vaginal cavity and release the active compound.

Formulations of the present invention which are suitable for vaginal administration also include pessaries, tampons, creams, gels, pastes, foams or spray formulations containing such carriers as are known in the art to be appropriate.

Dosage forms for the topical or transdermal administration of a compound of this invention include powders, sprays, ointments, pastes, creams, lotions, gels, solutions, patches and inhalants. The active compound may be mixed under sterile conditions with a pharmaceutically acceptable carrier, and with any preservatives, buffers, or propellants which may be required.

The ointments, pastes, creams, and gels may contain, in addition to an active compound of this invention, excipients, such as animal and vegetable fats, oils, waxes, paraffins, starch, tragacanth, cellulose derivatives, polyethylene glycols, silicones, bentonites, silicic acid, talc and zinc oxide, or mixtures thereof.

Powders and sprays can contain, in addition to a compound of this invention, excipients such as lactose, talc, silicic acid, aluminum hydroxide, calcium silicates and polyamide powder, or mixtures of these substances. Sprays can additionally contain customary propellants, such as chlorofluorohydrocarbons and volatile unsubstituted hydrocarbons, such as butane and propane.

Transdermal patches have the added advantage of providing controlled delivery of a compound of the present invention to the body. Dissolving or dispersing the compound in the proper medium can make such dosage forms. Absorption enhancers can also be used to increase the flux of the compound across the skin. Either providing a rate controlling membrane or dispersing the compound in a polymer matrix or gel can control the rate of such flux.

Ophthalmic formulations, eye ointments, powders, solutions and the like, are also contemplated as being within the scope of this invention.

Pharmaceutical compositions of this invention suitable for parenteral administration comprise one or more compounds of the invention in combination with one or more pharmaceutically-acceptable sterile isotonic aqueous or nonaqueous solutions, dispersions, suspensions or emulsions, or sterile powders which may be reconstituted into sterile injectable solutions or dispersions just prior to use, which may contain sugars, alcohols, antioxidants, buffers, bacteriostats, solutes which render the formulation isotonic with the blood of the intended recipient or suspending or thickening agents.

Examples of suitable aqueous and nonaqueous carriers, which may be employed in the pharmaceutical compositions of the invention include water, ethanol, polyols (such as glycerol, propylene glycol, polyethylene glycol, and the like), and suitable mixtures thereof, vegetable oils, such as olive oil, and injectable organic esters, such as ethyl oleate. Proper fluidity can be maintained, for example, by the use of coating materials, such as lecithin, by the maintenance of the required particle size in the case of dispersions, and by the use of surfactants.

These compositions may also contain adjuvants such as preservatives, wetting agents, emulsifying agents, and dispersing agents. Prevention of the action of microorganisms upon the subject compounds may be ensured by the inclusion of various antibacterial and antifungal agents, for example, paraben, chlorobutanol, phenol sorbic acid, and the like. It may also be desirable to include isotonic agents, such as sugars, sodium chloride, and the like into the compositions. In addition, prolonged absorption of the injectable pharmaceutical form may be brought about by the inclusion of agents which delay absorption such as aluminum monostearate and gelatin.

Delivery systems suitable for use with the present invention include time-release, delayed release, sustained release, or controlled release delivery systems, as described herein. Such systems may avoid repeated administrations of the active compounds of the invention in many cases, increasing convenience to the subject and the physician. Many types of release delivery systems are available and known to those of ordinary skill in the art. They include, for example, polymer based systems such as polylactic and/or polyglycolic acid, polyanhydrides, and polycaprolactone; nonpolymer systems that are lipid-based including sterols such as cholesterol, cholesterol esters, and fatty acids or neutral fats such as mono-, di- and triglycerides; hydrogel release systems; silastic systems; peptide based systems; wax coatings; compressed tablets using conventional binders and excipients; or partially fused implants. Specific examples include, but are not limited to, erosional systems in which the composition is contained in a form within a matrix, or diffusional systems in which an active component controls the release rate. The formulation may be as, for example, microspheres, hydrogels, polymeric reservoirs, cholesterol matrices, or polymeric systems. In some embodiments, the system may allow sustained or controlled release of the active compound to occur, for example, through control of the diffusion or erosion/degradation rate of the formulation. In addition, a pump-based hardware delivery system may be used in some embodiment of the invention.

Use of a long-term release implant may be particularly suitable in some cases. “Long-term release,” as used herein, means that the implant is constructed and arranged to deliver therapeutic levels of the composition for at least about 30 or about 45 days, for at least about 60 or about 90 days, or even longer in some cases. Long-term release implants are well known to those of ordinary skill in the art, and include some of the release systems described above.

In some cases, in order to prolong the effect of a drug, it is desirable to slow the absorption of the drug from subcutaneous or intramuscular injection. This may be accomplished by the use of a liquid suspension of crystalline or amorphous material having poor water solubility. The rate of absorption of the drug then depends upon its rate of dissolution, which in turn, may depend upon crystal size and crystalline form. Alternatively, delayed absorption of a parenterally administered drug form is accomplished by dissolving or suspending the drug in an oil vehicle.

Injectable depot forms are made by forming microencapsule matrices of the subject compounds in biodegradable polymers such as polylactide-polyglycolide. Depending on the ratio of drug to polymer, and the nature of the particular polymer employed, the rate of drug release can be controlled. Examples of other biodegradable polymers include poly(orthoesters) and poly(anhydrides). Depot injectable formulations are also prepared by entrapping the drug in liposomes or microemulsions, which are compatible with body tissue.

When the compounds of the present invention are administered as pharmaceuticals, to humans and animals, they can be given per se or as a pharmaceutical composition containing, for example, about 0.1% to about 99.5%, about 0.5% to about 90%, or the like, of active ingredient in combination with a pharmaceutically acceptable carrier.

The administration may be localized (i.e., to a particular region, physiological system, tissue, organ, or cell type) or systemic, depending on the condition to be treated. For example, the composition may be administered through parental injection, implantation, orally, vaginally, rectally, buccally, pulmonary, topically, nasally, transdermally, surgical administration, or any other method of administration where access to the target by the composition is achieved. Examples of parental modalities that can be used with the invention include intravenous, intradermal, subcutaneous, intracavity, intramuscular, intraperitoneal, epidural, or intrathecal. Examples of implantation modalities include any implantable or injectable drug delivery system. Oral administration may be useful for some treatments because of the convenience to the patient as well as the dosing schedule.

Regardless of the route of administration selected, the compounds of the present invention, which may be used in a suitable hydrated form, and/or the pharmaceutical compositions of the present invention, are formulated into pharmaceutically-acceptable dosage forms by conventional methods known to those of skill in the art.

The compositions of the present invention may be given in dosages, generally, at the maximum amount while avoiding or minimizing any potentially detrimental side effects. The compositions can be administered in effective amounts, alone or in a cocktail with other compounds, for example, other compounds that can be used to treat cancer. An effective amount is generally an amount sufficient to inhibit cancer within the subject.

One of skill in the art can determine what an effective amount of the composition is by screening the ability of the composition using any of the assays described herein. The effective amounts will depend, of course, on factors such as the severity of the condition being treated; individual patient parameters including age, physical condition, size, and weight; concurrent treatments; the frequency of treatment; or the mode of administration. These factors are well known to those of ordinary skill in the art and can be addressed with no more than routine experimentation. In some cases, a maximum dose be used, that is, the highest safe dose according to sound medical judgment.

Actual dosage levels of the active ingredients in the pharmaceutical compositions of this invention may be varied so as to obtain an amount of the active ingredient that is effective to achieve the desired therapeutic response for a particular patient, composition, and mode of administration, without being toxic to the patient.

The selected dosage level will depend upon a variety of factors including the activity of the particular compound of the present invention employed, or the ester, salt or amide thereof, the route of administration, the time of administration, the rate of excretion or metabolism of the particular compound being employed, the duration of the treatment, other drugs, compounds and/or materials used in combination with the particular compound employed, the age, sex, weight, condition, general health and prior medical history of the patient being treated, and like factors well known in the medical arts.

A physician or veterinarian having ordinary skill in the art can readily determine and prescribe the effective amount of the pharmaceutical composition required. For example, the physician or veterinarian could start doses of the compounds of the invention employed in the pharmaceutical composition at levels lower than that required to achieve the desired therapeutic effect and then gradually increasing the dosage until the desired effect is achieved.

In some embodiments, a compound or pharmaceutical composition of the invention is provided to a subject chronically. Chronic treatments include any form of repeated administration for an extended period of time, such as repeated administrations for one or more months, between a month and a year, one or more years, or longer. In many embodiments, a chronic treatment involves administering a compound or pharmaceutical composition of the invention repeatedly over the life of the subject. For example, chronic treatments may involve regular administrations, for example one or more times a day, one or more times a week, or one or more times a month. In general, a suitable dose such as a daily dose of a compound of the invention will be that amount of the compound that is the lowest dose effective to produce a therapeutic effect. Such an effective dose will generally depend upon the factors described above. Generally doses of the compounds of this invention for a patient, when used for the indicated effects, will range from about 0.0001 to about 100 mg per kg of body weight per day. The daily dosage may range from 0.001 to 50 mg of compound per kg of body weight, or from 0.01 to about 10 mg of compound per kg of body weight. In some cases, the dose may range from between about 5 and about 50 mg of compound per kg of body weight, between about 10 and about 40 mg of compound per kg of body weight, between about 10 and about 35 mg of compound per kg of body weight, or between about 15 and about 40 mg of compound per kg of body weight. However, lower or higher doses can be used. In some embodiments, the dose administered to a subject may be modified as the physiology of the subject changes due to age, disease progression, weight, or other factors.

If desired, the effective daily dose of the active compound may be administered as two, three, four, five, six or more sub-doses administered separately at appropriate intervals throughout the day, optionally, in unit dosage forms.

While it is possible for a compound of the present invention to be administered alone, it may be administered as a pharmaceutical formulation (composition) as described above.

The present invention also provides any of the above-mentioned compositions useful for treatment of cancer packaged in kits, optionally including instructions for use of the composition for the treatment of cancer. That is, the kit can include a description of use of the composition for participation in any biological or chemical mechanism disclosed herein associated with cancer or tumor. The kits can further include a description of activity of cancer in treating the pathology, as opposed to the symptoms of the cancer. That is, the kit can include a description of use of the compositions as discussed herein. The kit also can include instructions for use of a combination of two or more compositions of the invention. Instructions also may be provided for administering the drug by any suitable technique, such as orally, intravenously, or via another known route of drug delivery. The invention also involves promotion of the treatment of cancer according to any of the techniques and compositions and composition combinations described herein.

The compositions of the invention, in some embodiments, may be promoted for treatment of abnormal cell proliferation, cancers, or tumors, or includes instructions for treatment of accompany cell proliferation, cancers, or tumors, as mentioned above. In another aspect, the invention provides a method involving promoting the prevention or treatment of cancer via administration of any one of the compositions of the present invention, and homologs, analogs, derivatives, enantiomers and functionally equivalent compositions thereof in which the composition is able to treat cancers. As used herein, “promoted” includes all methods of doing business including methods of education, hospital and other clinical instruction, pharmaceutical industry activity including pharmaceutical sales, and any advertising or other promotional activity including written, oral and electronic communication of any form, associated with compositions of the invention in connection with treatment of cell proliferation, cancers or tumors. “Instructions” can define a component of promotion, and typically involve written instructions on or associated with packaging of compositions of the invention. Instructions also can include any oral or electronic instructions provided in any manner. The “kit” typically defines a package including any one or a combination of the compositions of the invention and the instructions, or homologs, analogs, derivatives, enantiomers and functionally equivalent compositions thereof, but can also include the composition of the invention and instructions of any form that are provided in connection with the composition in a manner such that a clinical professional will clearly recognize that the instructions are to be associated with the specific composition.

The kits described herein may also contain one or more containers, which can contain compounds such as the species, signaling entities, biomolecules, and/or particles as described. The kits also may contain instructions for mixing, diluting, and/or administrating the compounds. The kits also can include other containers with one or more solvents, surfactants, preservatives, and/or diluents (e.g., normal saline (0.9% NaCl), or 5% dextrose) as well as containers for mixing, diluting or administering the components to the sample or to the patient in need of such treatment.

The compositions of the kit may be provided as any suitable form, for example, as liquid solutions or as dried powders. When the composition provided is a dry powder, the powder may be reconstituted by the addition of a suitable solvent, which may also be provided. In embodiments where liquid forms of the composition are sued, the liquid form may be concentrated or ready to use. The solvent will depend on the compound and the mode of use or administration. Suitable solvents for drug compositions are well known and are available in the literature. The solvent will depend on the compound and the mode of use or administration.

The kit, in one set of embodiments, may comprise a carrier means being compartmentalized to receive in close confinement one or more container means such as vials, tubes, and the like, each of the container means comprising one of the separate elements to be used in the method. For example, one of the container means may comprise a positive control in the assay. Additionally, the kit may include containers for other components, for example, buffers useful in the assay.

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

As used herein, a “subject” or a “patient” refers to any mammal (e.g., a human), such as a mammal that may be susceptible to tumorigenesis or cancer. Examples include a human, a non-human primate, a cow, a horse, a pig, a sheep, a goat, a dog, a cat, or a rodent such as a mouse, a rat, a hamster, or a guinea pig. Generally, or course, the invention is directed toward use with humans. A subject may be a subject diagnosed with cancer or otherwise known to have cancer. In certain embodiments, a subject may be selected for treatment on the basis of a known cancer in the subject. In some embodiments, a subject may be selected for treatment on the basis of a suspected cancer in the subject. In some embodiments, a cancer may be diagnosed by detecting a mutation associate in a biological sample (e.g., urine, sputum, whole blood, serum, stool, etc., or any combination thereof. Accordingly, a compound or composition of the invention may be administered to a subject based, at least in part, on the fact that a mutation is detected in at least one sample (e.g., biopsy sample or any other biological sample) obtained from the subject. In some embodiments, a cancer may not have been detected or located in the subject, but the presence of a mutation associated with a cancer in at least one biological sample may be sufficient to prescribe or administer one or more compositions of the invention to the subject. In some embodiments, the composition may be administered to prevent the development of a cancer. However, in some embodiments, the presence of an existing cancer may be suspected, but not yet identified, and a composition of the invention may be administered to prevent further growth or development of the cancer.

It should be appreciated that any suitable technique may be used to identify or detect mutation and/or over-expression associated with a cancer. For example, nucleic acid detection techniques (e.g., sequencing, hybridization, etc.) or peptide detection techniques (e.g., sequencing, antibody-based detection, etc.) may be used. In some embodiments, other techniques may be used to detect or infer the presence of a cancer (e.g., histology, etc.).

The presence of a cancer can be detected or inferred by detecting a mutation, over-expression, amplification, or any combination thereof at one or more other loci associated with a signaling pathway of a cancer.

A “sample,” as used herein, is any cell, body tissue, or body fluid sample obtained from a subject. Non-limiting examples of body fluids include, for example, lymph, saliva, blood, urine, and the like. Samples of tissue and/or cells for use in the various methods described herein can be obtained through standard methods including, but not limited to, tissue biopsy, including punch biopsy and cell scraping, needle biopsy; or collection of blood or other bodily fluids by aspiration or other suitable methods.

The phrase “therapeutically effective amount” as used herein means that amount of a compound, material, or composition comprising a compound of the present invention which is effective for producing some desired therapeutic effect in a subject at a reasonable benefit/risk ratio applicable to any medical treatment. Accordingly, a therapeutically effective amount prevents, minimizes, or reverses disease progression associated with a cancer. Disease progression can be monitored by clinical observations, laboratory and imaging investigations apparent to a person skilled in the art. A therapeutically effective amount can be an amount that is effective in a single dose or an amount that is effective as part of a multi-dose therapy, for example an amount that is administered in two or more doses or an amount that is administered chronically.

Definitions of specific functional groups and chemical terms are described in more detail below. For purposes of this invention, the chemical elements are identified in accordance with the Periodic Table of the Elements, CAS version, Handbook of Chemistry and Physics, 75^{th} Ed., inside cover, and specific functional groups are generally defined as described therein. Additionally, general principles of organic chemistry, as well as specific functional moieties and reactivity, are described in Organic Chemistry, Thomas Sorrell, University Science Books, Sausalito: 1999, the entire contents of which are incorporated herein by reference.

The term “aliphatic,” as used herein, includes both saturated and unsaturated, nonaromatic, straight chain (i.e., unbranched), branched, acyclic, and cyclic (i.e., carbocyclic) hydrocarbons, which are optionally substituted with one or more functional groups. As will be appreciated by one of ordinary skill in the art, “aliphatic” is intended herein to include, but is not limited to, alkyl, alkenyl, alkynyl, cycloalkyl, cycloalkenyl, and cycloalkynyl moieties. Thus, as used herein, the term “alkyl” includes straight, branched and cyclic alkyl groups. An analogous convention applies to other generic terms such as “alkenyl”, “alkynyl”, and the like. Furthermore, as used herein, the terms “alkyl”, “alkenyl”, “alkynyl”, and the like encompass both substituted and unsubstituted groups. In certain embodiments, as used herein, “aliphatic” is used to indicate those aliphatic groups (cyclic, acyclic, substituted, unsubstituted, branched or unbranched) having 1-20 carbon atoms. Aliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

As used herein, the term “alkyl” is given its ordinary meaning in the art and refers to the radical of saturated aliphatic groups, including straight-chain alkyl groups, branched-chain alkyl groups, cycloalkyl (alicyclic) groups, alkyl substituted cycloalkyl groups, and cycloalkyl substituted alkyl groups. In some cases, the alkyl group may be a lower alkyl group, i.e., an alkyl group having 1 to 10 carbon atoms (e.g., methyl, ethyl, propyl, butyl, pentyl, hexyl, heptyl, octyl, nonyl, or decyl). In some embodiments, a straight chain or branched chain alkyl may have 30 or fewer carbon atoms in its backbone, and, in some cases, 20 or fewer. In some embodiments, a straight chain or branched chain alkyl may have 12 or fewer carbon atoms in its backbone (e.g., C₁-C₁₂ for straight chain, C₃-C₁₂ for branched chain), 6 or fewer, or 4 or fewer. Likewise, cycloalkyls may have from 3-10 carbon atoms in their ring structure, or 5, 6 or 7 carbons in the ring structure. Examples of alkyl groups include, but are not limited to, methyl, ethyl, propyl, isopropyl, cyclopropyl, butyl, isobutyl, t-butyl, cyclobutyl, hexyl, and cyclochexyl.

The term “alkylene” as used herein refers to a bivalent alkyl group. An “alkylene” group is a polymethylene group, i.e., —(CH₂)_{z}—, wherein z is a positive integer, e.g., from 1 to 20, from 1 to 10, from 1 to 6, from 1 to 4, from 1 to 3, from 1 to 2, or from 2 to 3. A substituted alkylene chain is a polymethylene group in which one or more methylene hydrogen atoms are replaced with a substituent. Suitable substituents include those described herein for a substituted aliphatic group.

Generally, the suffix “-ene” is used to describe a bivalent group. Thus, any of the terms defined herein can be modified with the suffix “-ene” to describe a bivalent version of that moiety. For example, a bivalent carbocycle is “carbocyclylene”, a bivalent aryl ring is “arylene”, a bivalent benzene ring is “phenylene”, a bivalent heterocycle is “heterocyclylene”, a bivalent heteroaryl ring is “heteroarylene”, a bivalent alkyl chain is “alkylene”, a bivalent alkenyl chain is “alkenylene”, a bivalent alkynyl chain is “alkynylene”, a bivalent heteroalkyl chain is “heteroalkylene”, a bivalent heteroalkenyl chain is “heteroalkenylene”, a bivalent heteroalkynyl chain is “heteroalkynylene”, and so forth.

The terms “alkenyl” and “alkynyl” are given their ordinary meaning in the art and refer to unsaturated aliphatic groups analogous in length and possible substitution to the alkyls described above, but that contain at least one double or triple bond respectively.

In certain embodiments, the alkyl, alkenyl and alkynyl groups employed in the invention contain 1-20 aliphatic carbon atoms. In certain other embodiments, the alkyl, alkenyl, and alkynyl groups employed in the invention contain 1-10 aliphatic carbon atoms. In yet other embodiments, the alkyl, alkenyl, and alkynyl groups employed in the invention contain 1-8 aliphatic carbon atoms. In still other embodiments, the alkyl, alkenyl, and alkynyl groups employed in the invention contain 1-6 aliphatic carbon atoms. In yet other embodiments, the alkyl, alkenyl, and alkynyl groups employed in the invention contain 1-4 carbon atoms. Illustrative aliphatic groups thus include, but are not limited to, for example, methyl, ethyl, n-propyl, isopropyl, allyl, n-butyl, sec-butyl, isobutyl, t-butyl, n-pentyl, sec-pentyl, isopentyl, t-pentyl, n-hexyl, sec-hexyl, moieties and the like, which again, may bear one or more substituents. Alkenyl groups include, but are not limited to, for example, ethenyl, propenyl, butenyl, 1-methyl-2-buten-1-yl, and the like. Representative alkynyl groups include, but are not limited to, ethynyl, 2-propynyl (propargyl), 1-propynyl and the like.

The term “cycloalkyl,” as used herein, refers specifically to groups having three to ten, preferably three to seven carbon atoms. Suitable cycloalkyls include, but are not limited to cyclopropyl, cyclobutyl, cyclopentyl, cyclohexyl, cycloheptyl and the like, which, as in the case of other aliphatic, heteroaliphatic, or hetercyclic moieties, may optionally be substituted with substituents including, but not limited to aliphatic; heteroaliphatic; aryl; heteroaryl; arylalkyl; heteroarylalkyl; alkoxy; aryloxy; heteroalkoxy; heteroaryloxy; alkylthio; arylthio; heteroalkylthio; heteroarylthio; —F; —Cl; —Br; —I; —OH; —NO₂; —CN; —CF₃; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ, wherein each occurrence of Rₓ independently includes, but is not limited to, aliphatic, heteroaliphatic, aryl, heteroaryl, arylalkyl, or heteroarylalkyl, wherein any of the aliphatic, heteroaliphatic, arylalkyl, or heteroarylalkyl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “heteroaliphatic,” as used herein, refers to an aliphatic moiety, as defined herein, which includes both saturated and unsaturated, nonaromatic, straight chain (i.e., unbranched), branched, acyclic, cyclic (i.e., heterocyclic), or polycyclic hydrocarbons, which are optionally substituted with one or more functional groups, and that contain one or more oxygen, sulfur, nitrogen, phosphorus, or silicon atoms, e.g., in place of carbon atoms.

In certain embodiments, heteroaliphatic moieties are substituted by independent replacement of one or more of the hydrogen atoms thereon with one or more substituents. As will be appreciated by one of ordinary skill in the art, “heteroaliphatic” is intended herein to include, but is not limited to, heteroalkyl, heteroalkenyl, heteroalkynyl, heterocycloalkyl, heterocycloalkenyl, and heterocycloalkynyl moieties. Thus, the term “heteroaliphatic” includes the terms “heteroalkyl,” “heteroalkenyl”, “heteroalkynyl”, and the like. Furthermore, as used herein, the terms “heteroalkyl”, “heteroalkenyl”, “heteroalkynyl”, and the like encompass both substituted and unsubstituted groups. In certain embodiments, as used herein, “heteroaliphatic” is used to indicate those heteroaliphatic groups (cyclic, acyclic, substituted, unsubstituted, branched or unbranched) having 1-20 carbon atoms. Heteroaliphatic group substituents include, but are not limited to, any of the substituents described herein, that result in the formation of a stable moiety (e.g., aliphatic, alkyl, alkenyl, alkynyl, heteroaliphatic, heterocyclic, aryl, heteroaryl, acyl, sulfinyl, sulfonyl, oxo, imino, thiooxo, cyano, isocyano, amino, azido, nitro, hydroxyl, thiol, halo, aliphaticamino, heteroaliphaticamino, alkylamino, heteroalkylamino, arylamino, heteroarylamino, alkylaryl, arylalkyl, aliphaticoxy, heteroaliphaticoxy, alkyloxy, heteroalkyloxy, aryloxy, heteroaryloxy, aliphaticthioxy, heteroaliphaticthioxy, alkylthioxy, heteroalkylthioxy, arylthioxy, heteroarylthioxy, acyloxy, and the like, each of which may or may not be further substituted).

The term “heteroalkyl” is given its ordinary meaning in the art and refers to an alkyl group as described herein in which one or more carbon atoms is replaced by a heteroatom. Suitable heteroatoms include oxygen, sulfur, nitrogen, phosphorus, and the like. Examples of heteroalkyl groups include, but are not limited to, alkoxy, alkoxyalkyl, amino, thioester, poly(ethylene glycol), and alkyl-substituted amino.

The terms “heteroalkenyl” and “heteroalkynyl” are given their ordinary meaning in the art and refer to unsaturated aliphatic groups analogous in length and possible substitution to the heteroalkyls described above, but that contain at least one double or triple bond respectively.

Some examples of substituents of the above-described aliphatic (and other) moieties of compounds of the invention include, but are not limited to aliphatic; heteroaliphatic; aryl; heteroaryl; alkylaryl; alkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CHF₂; —CH₂F; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)₂Rₓ; —NRₓ(CO)Rₓ wherein each occurrence of Rₓ independently includes, but is not limited to, aliphatic, alycyclic, heteroaliphatic, heterocyclic, aryl, heteroaryl, alkylaryl, or alkylheteroaryl, wherein any of the aliphatic, heteroaliphatic, alkylaryl, or alkylheteroaryl substituents described above and herein may be substituted or unsubstituted, branched or unbranched, cyclic or acyclic, and wherein any of the aryl or heteroaryl substituents described above and herein may be substituted or unsubstituted. Additional examples of generally applicable substituents are illustrated by the specific embodiments shown in the Examples that are described herein.

The term “aryl” is given its ordinary meaning in the art and refers to aromatic carbocyclic groups, optionally substituted, having a single ring (e.g., phenyl), multiple rings (e.g., biphenyl), or multiple fused rings in which at least one is aromatic (e.g., 1,2,3,4-tetrahydronaphthyl, naphthyl, anthryl, or phenanthryl). That is, at least one ring may have a conjugated pi electron system, while other, adjoining rings can be cycloalkyls, cycloalkenyls, cycloalkynyls, aryls and/or heterocyclyls. The aryl group may be optionally substituted, as described herein. Substituents include, but are not limited to, any of the previously mentioned substituents, i.e., the substituents recited for aliphatic moieties, or for other moieties as disclosed herein, resulting in the formation of a stable compound. In some cases, an aryl group is a stable mono- or polycyclic unsaturated moiety having preferably 3-14 carbon atoms, each of which may be substituted or unsubstituted. “Carbocyclic aryl groups” refer to aryl groups wherein the ring atoms on the aromatic ring are carbon atoms. Carbocyclic aryl groups include monocyclic carbocyclic aryl groups and polycyclic or fused compounds (e.g., two or more adjacent ring atoms are common to two adjoining rings) such as naphthyl groups.

The terms “heteroaryl” is given its ordinary meaning in the art and refers to aryl groups comprising at least one heteroatom as a ring atom. A “heteroaryl” is a stable heterocyclic or polyheterocyclic unsaturated moiety having preferably 3-14 carbon atoms, each of which may be substituted or unsubstituted. Substituents include, but are not limited to, any of the previously mentioned substituents, i.e., the substitutes recited for aliphatic moieties, or for other moieties as disclosed herein, resulting in the formation of a stable compound. In some cases, a heteroaryl is a cyclic aromatic radical having from five to ten ring atoms of which one ring atom is selected from S, O, and N; zero, one, or two ring atoms are additional heteroatoms independently selected from S, O, and N; and the remaining ring atoms are carbon, the radical being joined to the rest of the molecule via any of the ring atoms, such as, for example, pyridyl, pyrazinyl, pyrimidinyl, pyrrolyl, pyrazolyl, imidazolyl, thiazolyl, oxazolyl, isooxazolyl, thiadiazolyl, oxadiazolyl, thiophenyl, furanyl, quinolinyl, isoquinolinyl, and the like.

It will also be appreciated that aryl and heteroaryl moieties, as defined herein may be attached via an alkyl or heteroalkyl moiety and thus also include -(alkyl)aryl, -(heteroalkyl)aryl, -(heteroalkyl)heteroaryl, and -(heteroalkyl)heteroaryl moieties. Thus, as used herein, the phrases “aryl or heteroaryl moieties” and “aryl, heteroaryl, -(alkyl)aryl, -(heteroalkyl)aryl, -(heteroalkyl)heteroaryl, and -(heteroalkyl)heteroaryl” are interchangeable. Substituents include, but are not limited to, any of the previously mentioned substituents, i.e., the substituents recited for aliphatic moieties, or for other moieties as disclosed herein, resulting in the formation of a stable compound.

It will be appreciated that aryl and heteroaryl groups (including bicyclic aryl groups) can be unsubstituted or substituted, wherein substitution includes replacement of one or more of the hydrogen atoms thereon independently with any one or more of the following moieties including, but not limited to: aliphatic; alicyclic; heteroaliphatic; heterocyclic; aromatic; heteroaromatic; aryl; heteroaryl; alkylaryl; heteroalkylaryl; alkylheteroaryl; heteroalkylheteroaryl; alkoxy; aryloxy; heteroalkoxy; heteroaryloxy; alkylthio; arylthio; heteroalkylthio; heteroarylthio; F; Cl; Br; I; —OH; —NO₂; —CN; —CF₃; —CH₂F; —CHF₂; —CH₂CF₃; —CHCl₂; —CH₂OH; —CH₂CH₂OH; —CH₂NH₂; —CH₂SO₂CH₃; —C(O)Rₓ; —CO₂(Rₓ); —CON(Rₓ)₂; —OC(O)Rₓ; —OCO₂Rₓ; —OCON(Rₓ)₂; —N(Rₓ)₂; —S(O)Rₓ; —S(O)₂Rₓ; —NRₓ(CO)Rₓ wherein each occurrence of Rₓ independently includes, but is not limited to, aliphatic, alicyclic, heteroaliphatic, heterocyclic, aromatic, heteroaromatic, aryl, heteroaryl, alkylaryl, alkylheteroaryl, heteroalkylaryl or heteroalkylheteroaryl, wherein any of the aliphatic, alicyclic, heteroaliphatic, heterocyclic, alkylaryl, or alkylheteroaryl substituents described above and herein may be substituted or unsubstituted, branched or unbranched, saturated or unsaturated, and wherein any of the aromatic, heteroaromatic, aryl, heteroaryl, -(alkyl)aryl or -(alkyl)heteroaryl substituents described above and herein may be substituted or unsubstituted. Additionally, it will be appreciated, that any two adjacent groups taken together may represent a 4, 5, 6, or 7-membered substituted or unsubstituted alicyclic or heterocyclic moiety. Additional examples of generally applicable substituents are illustrated by the specific embodiments described herein.

The terms “halo” and “halogen” as used herein refer to an atom selected from the group consisting of fluorine, chlorine, bromine, and iodine.

It will be appreciated that the above groups and/or compounds, as described herein, may be optionally substituted with any number of substituents or functional moieties. That is, any of the above groups may be optionally substituted. As used herein, the term “substituted” is contemplated to include all permissible substituents of organic compounds, “permissible” being in the context of the chemical rules of valence known to those of ordinary skill in the art. In general, the term “substituted” whether preceded by the term “optionally” or not, and substituents contained in formulas of this invention, refer to the replacement of hydrogen radicals in a given structure with the radical of a specified substituent. When more than one position in any given structure may be substituted with more than one substituent selected from a specified group, the substituent may be either the same or different at every position. It will be understood that “substituted” also includes that the substitution results in a stable compound, e.g., which does not spontaneously undergo transformation such as by rearrangement, cyclization, elimination, etc. In some cases, “substituted” may generally refer to replacement of a hydrogen with a substituent as described herein. However, “substituted,” as used herein, does not encompass replacement and/or alteration of a key functional group by which a molecule is identified, e.g., such that the “substituted” functional group becomes, through substitution, a different functional group. For example, a “substituted phenyl group” must still comprise the phenyl moiety and cannot be modified by substitution, in this definition, to become, e.g., a pyridine ring. In a broad aspect, the permissible substituents include acyclic and cyclic, branched and unbranched, carbocyclic and heterocyclic, aromatic and nonaromatic substituents of organic compounds. Illustrative substituents include, for example, those described herein. The permissible substituents can be one or more and the same or different for appropriate organic compounds. For purposes of this invention, the heteroatoms such as nitrogen may have hydrogen substituents and/or any permissible substituents of organic compounds described herein which satisfy the valencies of the heteroatoms. Furthermore, this invention is not intended to be limited in any manner by the permissible substituents of organic compounds. The term “stable,” as used herein, preferably refers to compounds which possess stability sufficient to allow manufacture and which maintain the integrity of the compound for a sufficient period of time to be detected and preferably for a sufficient period of time to be useful for the purposes detailed herein.

Examples of substituents include, but are not limited to, halogen, azide, alkyl, aralkyl, alkenyl, alkynyl, cycloalkyl, hydroxyl, alkoxyl, amino, nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN, aryl, aryloxy, perhaloalkoxy, aralkoxy, heteroaryl, heteroaryloxy, heteroarylalkyl, heteroaralkoxy, azido, amino, halide, alkylthio, oxo, acylalkyl, carboxy esters, -carboxamido, acyloxy, aminoalkyl, alkylaminoaryl, alkylaryl, alkylaminoalkyl, alkoxyaryl, arylamino, aralkylamino, alkylsulfonyl, -carboxamidoalkylaryl, -carboxamidoaryl, hydroxyalkyl, haloalkyl, alkylaminoalkylcarboxy-, aminocarboxamidoalkyl-, cyano, alkoxyalkyl, perhaloalkyl, arylalkyloxyalkyl, and the like.

The following applications are incorporated herein by reference: application claims priority under 35 U.S.C. §119(e) to U.S. provisional patent applications, U.S. Ser. No. 61/982,075, filed Apr. 21, 2014, entitled “RHENIUM(V)-OXO COMPLEXES: A NEW GENERATION OF POTENT ANTICANCER AGENTS,” by Stephen J. Lippard, et al., and U.S. Ser. No. 61/991,271, filed May 9, 2014, entitled “COMPOSITIONS AND METHODS COMPRISING RHENIUM FOR THE TREATMENT OF CANCERS,” by Stephen J. Lippard, et al.

The following examples are intended to illustrate certain embodiments of the present invention, but do not exemplify the full scope of the invention.

### Example 1

Two rhenium(v) oxo complexes (1 and 2; see Scheme 1) were prepared by reacting ReOCl₃(PPh₃)₂ with one equivalent of the corresponding bidentate ligand in methanol. The complexes were isolated in reasonable yields as pale green solids and fully characterized by NMR and IR spectroscopy, ESI-MS spectrometry, and elemental analysis. Variable-temperature ¹H NMR studies showed that the complexes were stable in DMSO and remained intact at elevated temperatures (up to 75° C.).

In vitro toxicity of the rhenium (v) oxo complexes, 1 and 2 towards a panel of human cell lines was determined using the colorimetic MTT [[3-(4,5-dimethylithiazol-2-yl)-2,5-diphenyltetrazolium bromide] assay. The IC₅₀ values (concentration required to induce 50% inhibition) were derived from dose-response curves and are summarized in Table 1. The complexes displayed nanomolar potency toward cancer cells, with good selectivity over normal fibroblast cells (up to 10-fold). Notably 1 displayed higher (e.g., 37-fold or 20-fold) toxicity for lung carcinoma A549 cells than clinically administered cisplatin. Furthermore, 1 and 2 killed cisplatin-resistant ovarian carcinoma cells (A2780CP70) with up to 15-times better efficacy than the cisplatin-sensitive cells (A2780), indicative of no cross-resistance. Remarkably, the rhenium complexes exhibited ca. 200-fold greater potency towards cisplatin-resistant ovarian carcinoma cells (A2780CP70) than cisplatin. Cisplatin-resistant cancers could therefore be targeted using 1 and 2.

Extensive cell-based assays have been performed to elucidate the mechanism of action 1 and 2. Both complexes induce G1-phase cell cycle arrest, intracellular ROS production, propidium iodide uptake, RIP-RIP3 necrosome formation and RIP-dependent cell death, these features are consistent with programmed necrosis.

Most metal-based anticancer agents function by targeting and damaging nuclear DNA thereby inducing apoptotic cell death. Cytotoxic compounds may also kill cells through non-apoptotic cell death pathways including autophagy and necrosis. Although necrosis was previously believed to be a random, unregulated process, it is now understood that programmed necrosis, also known as necroptosis, does occur. For cancers that have evolved resistance to apoptotic cell death, compounds capable of inducing non-apoptotic cell death offer a viable alternative. This example describes two rhenium compounds that induce necroptosis in cancer cells. Their mechanism of action is different from all or most clinically administered metal-based anticancer drug. Therefore the rhenium compounds presented here, could be used to overcome chemotherapeutic-resistant tumors.

The compounds described in this example represent a new class of anticancer agents. The rhenium compounds display a different mechanism of action and spectrum of activity to cisplatin, the archetypical metal-based anticancer drug.

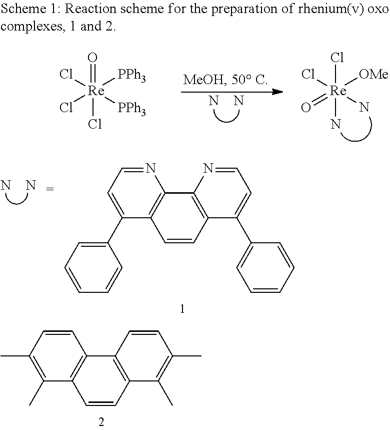

### Example 2

This example describes the non-limiting synthesis and results relating to non-limiting rhenium compounds.

Synthesis and Characterization.

The rhenium(V) oxo complexes 1 and 2 (see Scheme 1) were prepared by the reaction of [ReOCl₃(PPh₃)₂] with 1.5 equiv of the corresponding bidentate ligand in methanol (Scheme 1). The complexes were isolated in reasonable yields as pale green solids and fully characterized by NMR and IR spectroscopy and ESI mass spectrometry. The purity of the complexes was confirmed by elemental analysis. Variable-temperature 1H NMR spectroscopic studies in dimethylsulfoxide (DMSO) revealed the complexes to be stable and to remain intact at elevated temperatures (e.g., up to 75° C.).

The lipophilicity of the rhenium(V) oxo complexes, 1 and 2, was determined by measuring the extent to which they partition between octanol and water, P_{o/w} or P. The

TABLE 2
IC₅₀ Values (nM) of 1, 2, and Cisplatin against a
Panel of Cisplatin-Resistant Cell Lines and Confluent
Lung Carcinoma A549 Cells after 72 h Exposure^{a}

| cell line | cancer type | 1 | 2 | cisplatin |
|---|---|---|---|---|
| HT-29 | colorectal | 85 ± 11 | 95 ± 20 | 29640 ± 1329 |
| | adeno- | | | |
| | carcinoma | | | |
| MDA- | breast | 475 ± 161 | 1735 ± 275 | 43600 ± 7071 |
| MB-231 | adeno- | | | |
| | carcinoma | | | |
| MCF-7 | breast | 285 ± 35 | 805 ± 21 | 9740 ± 537 |
| | adeno- | | | |
| | carcinoma | | | |
| PC-3 | prostate | 270 ± 14 | 780 ± 10 | 10250 ± 919 |
| | adeno- | | | |
| | carcinoma | | | |
| DU 145 | prostate | 2840 ± 381 | 1370 ± 84 | >100000 |
| | carcinoma | | | |
| A549 | lung | 8610 ± 749 | 5245 ± 1986 | 9420 ± 1937 |
| (con- | carcinoma | | | |
| fluent) | | | | |

^{a}The errors represent standard deviations.

experimentally determined log P values are 1.20 for 1, and 0.95 for 2. The hydrophobic character of the rhenium(V) oxo complexes suggests that they will be taken up well by cells.

In Vitro Potency.

The in vitro effect of rhenium(V) oxo complexes 1 and 2 toward a panel of human cell lines was determined by the colorimetric MTT [3-(4,5-dimethylthiazol-2-yl)-2,5-diphenyltetrazolium bromide] assay. Cisplatin was also included as a control. The IC₅₀ values, or concentration required to induce 50% cell death, were derived from dose-response curves and are summarized in Table 1. In cancer cells, the IC₅₀ values of 1

TABLE 1
IC₅₀ Values (nM) of 1, 2, and Cisplatin against Various
Cancerous and Healthy Cell Lines after 72 h Exposure^{a}

| cell line | cancer type | 1 | 2 | cisplatin |
|---|---|---|---|---|
| A549 | lung carcinoma | 207 ± 4 | 157 ± 15 | 3230 ± 467 |
| HeLa | cervical | 445 ± 4 | 695 ± 21 | 4100 ± 113 |
| | adeno- | | | |
| | carcinoma | | | |
| U2OS | bone | 274 ± 6 | 209 ± 31 | 4600 ± 600^{b} |
| | osteosarcoma | | | |
| NTERA-2 | testis | 230 ± 28 | 255 ± 35 | 385 ± 49 |
| | carcinoma | | | |
| A2780 | ovarian | 670 ± 40 | 150 ± 10 | 700 ± 200^{b} |
| | carcinoma | | | |
| A2780CP70 | ovarian | 42 ± 15 | 56 ± 2 | 8415 ± 205 |
| | carcinoma | | | |
| MRC-5 | lung fibroblast | 1351 ± 228 | 709 ± 76 | 5300 ± 600^{b} |

^{a}The errors represent standard deviations.
^{b}IC₅₀ values taken from ref 45.

and 2 were in the sub-micromolar range, whereas in normal fibroblast cells, the IC₅₀ values of 1 and 2 were in the micromolar range (about 10-fold higher). The potency of the rhenium complexes was significantly higher than that of cisplatin for the cell lines tested. Notably, the IC₅₀ value of 2 is 20 times lower in lung carcinoma A549 cells than the IC₅₀ value of cisplatin. The high potency observed for 1 and 2 can, in part, be attributed to their inherent lipophilic character (log P=1.20 for 1, and 0.95 for 2). Indeed, the IC₅₀ values of cytotoxic platinum complexes of comparable lipophilicity were similar to those observed for 1 and 2 in HeLa cervical adenocarcinoma cells. Specifically, the IC₅₀ values in HeLa cervical adenocarcinoma cells of ester-bearing bis(carboxylato)dichlorido(ethane-1,2-diamine)platinum(IV) complexes with log P values of 0.70 and 1.69 were 110 nM and 32 nM, respectively. Furthermore, the rhenium complexes were not cross-resistant with cisplatin, as demonstrated by their ability to kill cisplatin-resistant ovarian carcinoma cells (A2780CP70) with up to 15 times greater potency than cisplatin-sensitive cells (A2780). Given the ability of 1 and 2 to selectively kill ovarian cisplatin-resistant cells over the corresponding cisplatin-sensitive cells, their potency against other cisplatin-resistant cell lines such as HT-29 (colorectal adenocarcinoma), MDA-MB-231 (breast adenocarcinoma), PC-3 (prostate adenocarcinoma), MCF-7 (breast adenocarcinoma), and DU 145 (prostate carcinoma) were evaluated. The rhenium complexes displayed nanomolar and sub-micromolar toxicities toward the cisplatin-resistant cells (Table 2). The IC₅₀ values for 1 and 2 were 300-fold lower in colorectal adenocarcinoma HT-29 cells than the IC₅₀ value of cisplatin. Although cisplatin is one of the most successful broad-spectrum anticancer drugs in clinical use, several tumors exhibit resistance. A plethora of molecular mechanisms account for cisplatin resistance, including reduced intracellular accumulation, increased sequestration by scavengers, efficient DNA repair, and deregulation of proteins involved in the DNA damage and apoptotic cell death pathways. Therefore, compounds such as 1 and 2, which can overcome cisplatin resistance, hold significant therapeutic potential. To further investigate this potential, cytotoxicity studies were conducted with confluent A549 cells (Table 2). The IC₅₀ values for 1 and 2 were 40-fold higher in confluent A549 cells than in A549 cells in log phase growth. This result highlights the ability of 1 and 2 to selectively kill fast-growing cancer cells.

Cellular Mechanism of Action and Mode of Cell Death.

To gain insight into how the rhenium complexes induce cell death, 1 and 2 were analyzed by a functional strategy employing a RNAi signature assay to predict the mechanism of cytotoxic drug action. This RNAi-based methodology utilizes a fluorescence competition assay with lymphoma cells that are partially infected with eight distinct short hairpin RNAs (shRNAs). shRNA-bearing cells will either enrich or deplete relative to the uninfected population based on the survival advantage or disadvantage conferred by a given shRNA. The responses of these cells compose signatures, which have been obtained from classes of clinically used cytotoxic agents. These signatures comprise a reference set which is then informatically classified by a probabilistic K-nearest neighbors algorithm to determine whether a new compound belongs to a class in the reference set or requires a new category not yet represented. Neither 1 nor 2 classified as belonging to any category of drug mechanism present in the reference set, and thus they represent potentially novel mechanisms of drug action.

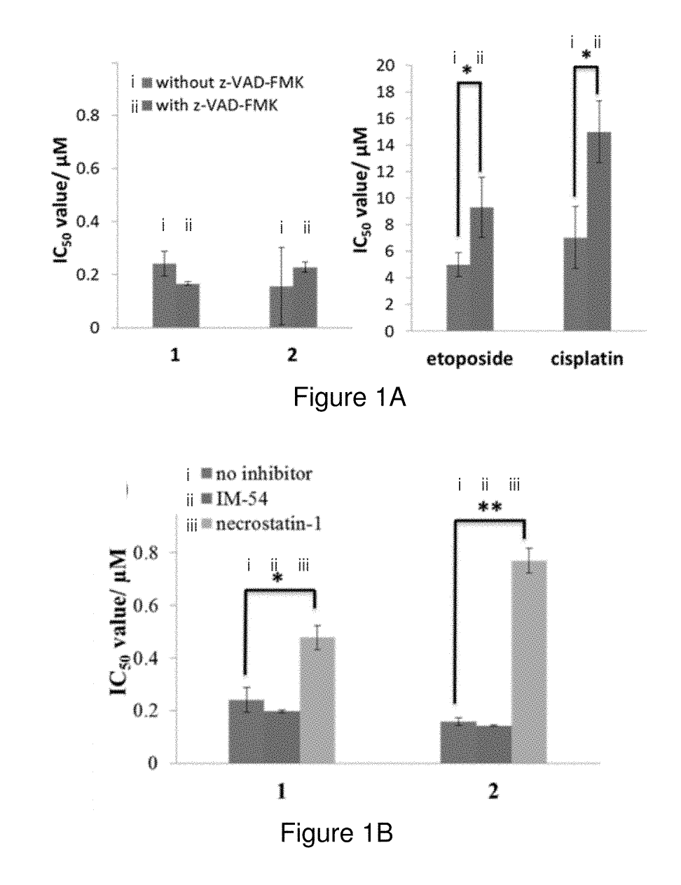

In order to determine the cell-killing mechanism of 1 and 2, cytotoxicity studies in the presence of apoptosis and necrosis inhibitors were conducted. Upon addition of z-VAD-FMK, a potent inhibitor of caspase-mediated apoptosis, the ability of 1 and 2 to kill A549 cells remained largely unaltered, indicative of a non-apoptotic cell death program (FIG. 1A). By contrast, the IC₅₀ values for known apoptosis-inducing agents such as etoposide and cisplatin increased significantly (t test, p<0.05) in the presence of the inhibitor (FIG. 1A). Immunoblotting studies showed that proteins implicated in the apoptotic cell death pathway, namely, cleaved caspases 7 and 9, were not detected in 1- and 2-treated A549 cells (50-500 nM for 72 h), providing further evidence for a non-apoptotic program. The possibility that 1 and 2 induce necroptosis was then investigated. Necroptosis is a well-regulated mode of cell death that is different from unregulated necrosis and apoptosis. Unlike unregulated necrosis, which can be induced by H₂O₂ or heat, necroptosis generally involved the interaction of protein kinases, RIP1 and RIP3, to initiate cell disintegration. This process can be blocked by necrostatin-1, a potent RIP1 kinase inhibitor. To determine whether 1 and 2 induced necroptosis and/or uncontrolled necrosis, cytotoxicity studies were conducted in the presence of necrostatin-1 (60 μM) and IM-54 (10 μM), an inhibitor of H₂O₂-induced necrosis. Co-incubation with necrostatin-1 markedly decreased the toxicity of 1 and 2 (t test, p<0.05) against A549, PC-3, and HT-29 cells (FIG. 1B). A similar effect was also observed for shikonin, a naturally occurring compound known to induce necroptosis in certain cell types. In contrast, co-treatment with IM-54 did not significantly affect the toxicity of 1 and 2 (FIG. 1B). Taken together, the cytotoxicity data suggest that 1 and 2 induce RIP1-RIP3 (necrosome)-mediated necroptosis, rather than uncontrolled necrosis or apoptosis. Immunoblotting studies revealed that the overall expression level of RIP1 and RIP3 in A549 cells remained unchanged with increasing 1 and 2 dosages. Therefore, 1- and 2-induced cell death relies on RIP1-RIP3 complex formation and not on the expression levels of the individual protein kinases. RIP1 can also form a cytosolic complex with Fas-associated death domain (FADD) and caspase 8, known as a ripoptosome, to initiate apoptosis (through caspase 8 cleavage). Immunoblotting studies showed that FADD and cleaved caspase 8 expression remained unaltered with increasing 1 and 2 concentration, indicating that ripoptosome formation is likely not responsible for 1- and 2-induced cell death. This is consistent with the fact that 1- and 2-treated A549 cells do not undergo apoptosis.

In FIG. 1: (A) IC₅₀ values (in μM) of 1, 2, etoposide, and cisplatin against A549 cells in the absence and presence of apoptosis inhibitor, z-VAD-FMK (5 μM), after 72 h incubation. (B) IC₅₀ values (in μM) of 1 and 2 against A549 cells in the absence and presence of H₂O₂-induced necrosis inhibitor, IM-54 (10 μM), and necroptosis inhibitor, necrostatin-1 (60 μM), after 72 h incubation. Student's t test, p<0.05 or 0.01. Error bars represent standard deviations.

Characterization of Necroptotic Features.

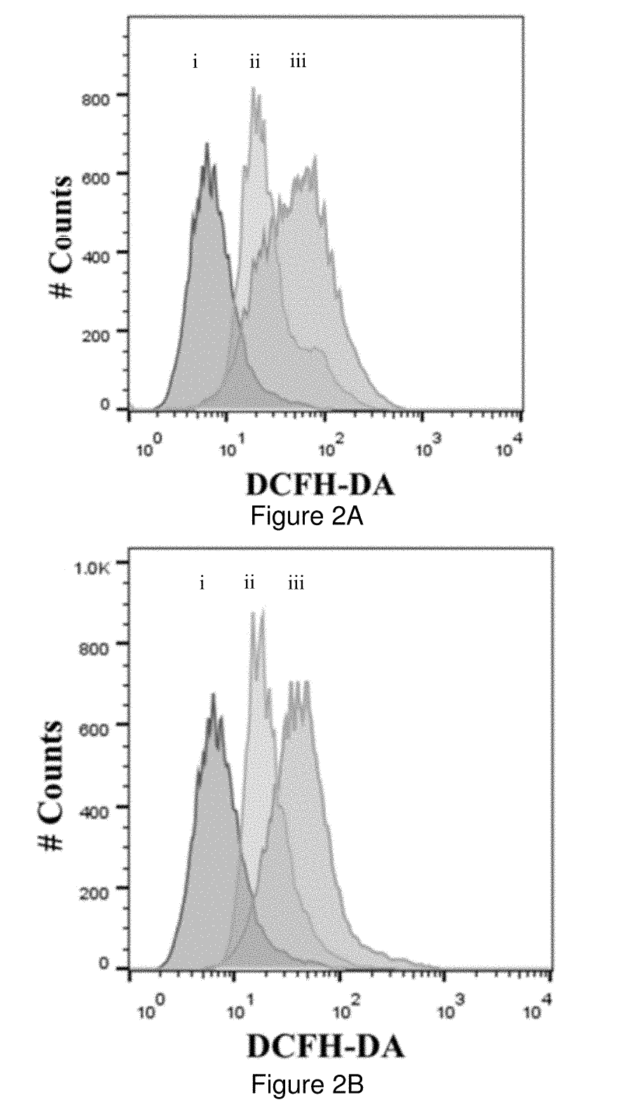

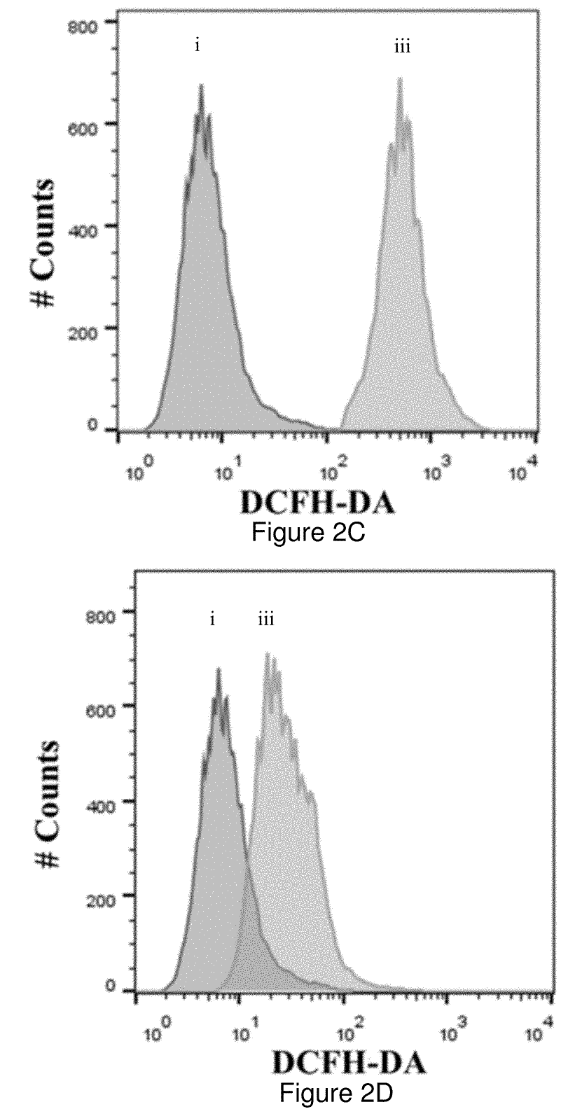

Having established that necrosome formation is a determinant of 1 and 2 activity, additional studies were performed to understand the cascade of events leading from necrosome formation to cell death. Necrosomes generate abnormally high levels of mitochondrial ROS, leading to ATP depletion and eventual degradation of the mitochondrial membrane potential. With this fact in mind, intracellular ROS production was quantified by flow cytometry using 6-carboxy-2′,7′-dichlorodihydrofluorescein diacetate (DCFH-DA), a well-established ROS indicator. A549 cells incubated with 1 and 2 (20 μM for 12 h) displayed markedly higher levels of ROS than untreated control cells (FIGS. 2A and 2B). A549 cells dosed with H₂O₂ (1 mM for 1 h, ROS-inducer) and shikonin (20 μM for 12 h, necroptosis-inducer) also exhibited significantly higher levels of measurable ROS than untreated cells (FIGS. 2C and 2D). Remarkably, 1- and 2-induced ROS production was attenuated in the presence of necrostatin-1 (60 μM) (FIGS. 2A and 2B), suggesting that the RIP1-RIP3 kinase complex plays a role in modulating intracellular ROS production.

In FIG. 2: (A) Representative histograms displaying the green fluorescence emitted by DCFH-DA-stained A549 cells (i) and A549 cells treated with 1 (20 μM for 12 h) (iii) or 1 (20 μM for 12 h) with nectrostatin-1 (60 μM for 12 h) (ii). (B) Representative histograms displaying the green fluorescence emitted by DCFH-DA-stained A549 cells (i) and A549 cells treated with 2 (20 μM for 12 h) (iii) or 2 (20 μM for 12 h) with nectrostatin-1 (60 μM for 12 h) (ii). (C) Representative histograms displaying the green fluorescence emitted by DCFH-DA-stained A549 cells (i) and A549 cells treated with H₂O₂ (1 mM for 1 h) (iii). (D) Representative histograms displaying the green fluorescence emitted by DCFH-DA-stained A549 cells (i) and A549 cells treated with shikonin (20 μM for 12 h) (iii).

The effect of 1 and 2 on the mitochondrial membrane potential was assessed by flow cytometry, using the JC-1 assay (5,5′,6,6′-tetrachloro-1,1′,3,3′-tetraethylbenzimidazolyl carbo-cyanine iodide). JC-1 is a cationic lipophilic dye that localizes in the mitochondria of healthy cells as red-emitting aggregates. If the mitochondrial membrane potential is disrupted, JC-1 forms green-emitting monomers. A549 cells incubated with 1 and 2 (20 μM for 12 h) displayed increased green fluorescence compared to untreated cells, indicative of mitochondrial membrane disruption. A similar result was observed for A549 cells dosed with carbonyl cyanide m-chlorophenyl hydrazone (CCCP) (5 μM for 12 h), a known mitochondrial membrane depolarizer, and shikonin (20 μM for 12 h), a necroptosis-inducing agent. Notably, 1- and 2-induced mitochondrial membrane depletion was amplified with necrostatin-1, suggesting that 1 and 2 may target mitochondria and induce mitochondrial dysfunction, independent of RIP1-RIP3 formation. This could explain the high residual toxicity (>1 μM) observed for A549 cells co-incubated with the rhenium complexes (1 and 2) and necrostatin-1 (FIG. 1B).

Intracellular ROS production and mitochondrial membrane depletion contribute to necroptosis. Cells undergoing necroptosis display necrosis-like morphological features such as loss of cell membrane integrity, increase in organelle and cell volume (oncosis), and intact nuclear membrane. To further test whether 1- and 2-treatment can trigger necroptosis, Hoechst 33258/propidium iodide (PI) double staining was carried out to determine nuclear membrane morphology and integrity. Hoechst 33258 is a DNA minor groove binder that is routinely used to visualize the nucleus without the need for cell permeabilization. When used without cell permeabilization agents, PI stains the nuclei of necrotic cells. Early-stage apoptotic and normal cells maintain cell membrane integrity and thus are not stained by PI. A549 cells were treated with 1 and 2 (20 μM for 12 h), incubated with Hoechst 33258 and PI, and imaged using a fluorescence microscope. Untreated A549 cells exhibited bright blue nuclei, owing to Hoechst 33258 uptake. Cells incubated with 1 and 2 displayed pink nuclei, owing to Hoechst 33258 and PI uptake, which is consistent with necroptosis. Furthermore, 1- and 2-treated cells showed clear signs of plasma membrane disintegration with undamaged nuclei. A549 cells co-incubated with 1 or 2 and necrostatin-1 (60 μM for 12 h) were unstained by PI, suggesting that necrostatin-1 is able to block 1- and 2-induced necroptosis. Overall, the microscopy data suggest that necrosome formation contributes to the necrosis-like morphological features observed upon treatment with 1 and 2. To further validate this result, A549 cells were treated under the same conditions as above, stained with PI, and analyzed by flow cytometry. Complementary to the microscopy results, 1- and 2-treated cells exhibited higher PI uptake compared to untreated control cells, indicative of necrotic cell death. The flow cytometry data also showed that necrostatin-1 could block 1- and 2-mediated PI uptake. Additional studies showed that pretreatment of A549 cells with N-acetylcysteine (3 mM for 1 h), a ROS inhibitor, significantly decreased 1- and 2-induced PI uptake. This result suggests that intracellular ROS generation play a role in the necroptotic mechanism of action of 1 and 2.

PARP-1- and p53-Independent Necroptosis.

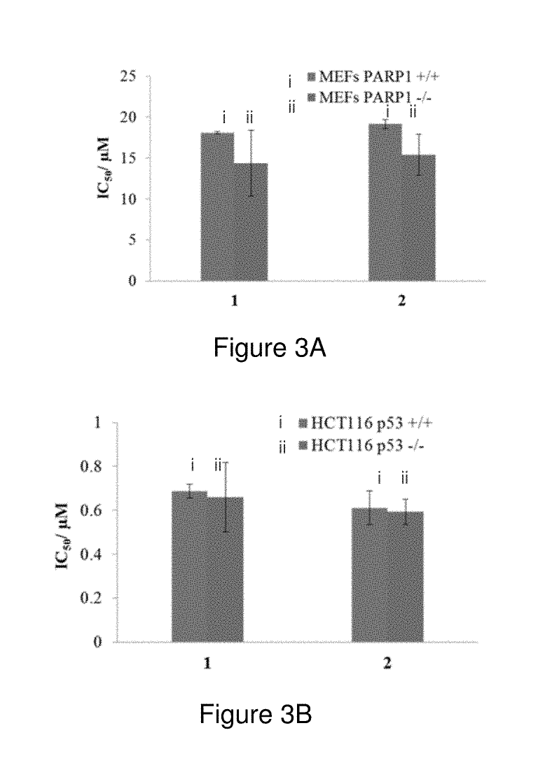

Apart from necrosome formation, necroptosis may also result from the overactivation of poly(ADP-ribose) polymerase (PARP-1). PARP-1 is a nuclear enzyme that is involved in DNA repair and transcriptional regulation. DNA damage can trigger PARP-1 activity, resulting in ATP and NAD depletion and bioenergetics-mediated cell death. To determine whether PARP-1 activity is a factor in 1- and 2-mediated cell death, cytotoxicity assays were conducted with wild-type mouse embryonic fibroblast cells (MEFs PARP-1+/+) and the corresponding PARP-1-null cells (MEFs PARP-1 −/−). The IC₅₀ values for 1 and 2 were similar for MEFs PARP-1+/+ and MEFs PARP-1 −/− cells, indicating that 1- and 2-induced necroptosis is independent of PARP-1 function (FIG. 3A). This result is consistent with immunoblotting studies, which revealed that treatment with 1 and 2 did not up-regulate canonical markers of DNA damage, such as the phosphorylated forms of H2AX (γH2AX) and CHK2. Recently, p53 has also been reported to play a role in necroptosis. p53 induces cathepsin Q, a lysosomal protease that cooperates with ROS to execute necrosis. To investigate whether p53 might play a role in 1- and 2-mediated necroptosis, cytotoxicity studies were conducted with HCT116 p53^{+/+} and HCT116 p53^{-/-} cells. The potency of 1 and 2 was statistically similar for HCT116 p53^{+/+} and HCT116 p53^{-/-} cells, indicating that 1 and 2 induce necroptosis in a manner that is independent of p53 (FIG. 3B). This conclusion is consistent with the RNAi signatures, which revealed that p53 is not important in the cellular response evoked by the complexes, especially for 1. Apart from the implications of this result for the mechanism of action of 1 and 2, it is clinically very appealing because p53 is mutated, defective, or inactivated in several chemoresistant cancers.

In FIG. 3: (A) IC₅₀ values (in μM) of 1 and 2 against MEFs PARP-1^{+/+} and MEFs PARP-1^{-/-} cells after 72 h incubation. (B) IC₅₀ values (in μM) of 1 and 2 against HCT116 p53^{+/+} and HCT116 p53^{-/-} cells after 72 h incubation.

Cell Cycle Analysis.

To gain a more complete understanding of the cellular response evoked, DNA-flow cytometric studies were conducted to determine the effect of 1 and 2 on the cell cycle. A549 cells were treated with 1 or 2 (2 μM), and the cell cycle was determined over the course of 72 h. After 24 h treatment, both complexes stalled the cell cycle at the G1 phase. Cells treated with 1 remained stalled at the G1 phase after 48 h. Upon further incubation (72 h), large populations of cell debris were detected (32%), indicative of cell death. Cells incubated with 2 for 48 and 72 h also displayed large populations of debris (26% and 38%, respectively). G1-phase cell cycle arrest followed by immediate cell death is characteristic of programmed necrosis.

In Vivo Toxicity and Stability in Whole Human Blood.

Given the impressive in vitro data acquired for 1 and 2, an in vivo study was conducted with C57BL/6 mice to determine acute toxicity and possible side effects. Single doses of 1 and 2 (3, 7, 11, 15, 20, and 36 mg/kg) in saline were administered by intraperitoneal injection. The mice were then monitored for signs of pain, distress, and weight loss for 6 days post-treatment. The compounds exhibited no toxicity in mice, as gauged by a lack of weight loss after treatment. The change in weight of mice after a single dose of 1 and 2 at the maximum solubility of the complexes (36 mg/kg) was determined. A single 30 mg/kg dose of cisplatin induces acute nephrotoxicity in C57BL/6 mice. The in vivo data highlight the relatively low toxicity of 1 and 2 compared to cisplatin in C57BL/6 mice. The pharmacological toxicity profile of 1 and 2 is very appealing in terms of further preclinical studies.

The stability of biologically active compounds in human blood is vitally important for their potential application in clinical settings. The stability of 1 in whole human blood using a recently developed protocol was investigated. The method exploits the ability of octanol to extract hydrophobic metal complexes such as 1. The rhenium complex 1 (500 μM) was incubated with fresh human blood at 37° C., and aliquots were extracted into octanol at various time points. The amount of 1 in the octanol extracts (corresponding to unreacted 1) was measured by graphite furnace atomic absorption spectroscopy (GFAAS). The data revealed that the half-life of 1 in human blood is 29.1 min, comparable to that reported for cisplatin (t_{1/2}=21.6 min).

In conclusion, two rhenium(V) oxo complexes were prepared, and their in vitro properties were investigated. The complexes selectively kill cancer cells over normal cells and display markedly higher cell toxicity than cisplatin. Remarkably, the IC₅₀ values of 1 and 2 are 2 orders of magnitude lower in colorectal adenocarcinoma cells than the IC₅₀ value of cisplatin. Cells treated with 1 and 2 displayed features consistent with programmed necrosis (necroptosis), including RIP1-RIP3-dependent intracellular ROS production, cell membrane disruption, PI uptake, mitochondrial damage, and G1 cell cycle arrest. Given the inherent and/or acquired resistance of tumors toward apoptosis-inducing chemotherapies, compounds such as 1 and 2, capable of killing cancer cells through necroptosis, are highly sought-after when selecting preclinical drug candidates for chemoresistant malignancies.

Materials.

All synthetic procedures were performed under normal atmospheric conditions without exclusion of oxygen or moisture. The bidentate aromatic ligands 4,7-diphenyl-1,10-phenanthroline and 3,4,7,8-tetramethyl-1,10-phenanthroline were purchased from Sigma-Aldrich and used as received. ReOCl₃(PPh₃)₂ was prepared as previously reported. The synthesis of 1 has been reported previously, but the procedure reported here is novel. Analytical-grade acetone and dichloromethane were used as solvents. Physical Measurements. NMR measurements were recorded on a Bruker 400 MHz spectrometer in the MIT Department of Chemistry Instrumentation Facility (DCIF) at 20° C. ¹H and ¹³C{¹H} NMR chemical shifts were referenced internally to residual solvent peaks or relative to tetramethylsilane (SiMe₄, δ=0.00 ppm). Fourier transform infrared (FTIR) spectra were recorded with a ThermoNicolet Avatar 360 spectrophotometer upon preparation of the samples as KBr disks. The spectra were analyzed using the OMNIC software. GFAAS was carried out using a Perkin-Elmer AAnalyst600 spectrometer.

### Synthesis of [ReO(OMe)(4,7-diphenyl-1,10-phenanthroline)-Cl₂] (1)

[ReOCl₃(PPh₃)₂] (63.8 mg, 0.08 mmol) was suspended in methanol (15 mL) and heated to 50° C. To this mixture was added a methanolic solution (5 mL) of 7-diphenyl-1,10-phenanthroline (34.0 mg, 0.10 mmol). The resultant mixture was heated under reflux for 24 h to give a deep purple solution with a pale green precipitate. The precipitate was filtered and then washed with hot methanol, cold methanol, and diethyl ether. The rhenium(V) oxo complex was isolated as a pale green solid. Yield: 19.8 mg (37%). Mp 247° C. (dec). ¹H NMR (400 MHz, DMSO-d₆): δ 10.08 (d, 2H), 8.48 (d, 2H), 8.31 (s, 2H), 7.83 (m, 4H), 7.73 (m, 6H), 2.56 (s, 3H). IR (KBr, cm⁻¹): 941.51 (Re═O), 508.42 (Re—OMe). ESI-MS (MeOH/DMSO): m/z 605.0 ([M-OMe]⁺, calcd 605.0). Anal. Calcd for 1, C₂₅H₁₉Cl₂N₂O₂Re: C, 47.17; H, 3.01; N, 4.40. Found: C, 46.79; H, 3.05; N, 4.35.

### Synthesis of [ReO(OMe)(3,4,7,8-tetramethyl-1,10-phenanthroline)Cl₂] (2)

[ReOCl₃(PPh₃)₂] (50.0 mg, 0.06 mmol) was suspended in methanol (15 mL) and heated to 50° C. To this mixture was added a methanolic solution (5 mL) of 3,4,7,8-tetramethyl-1,10-phenanthroline (21.85 mg, 0.09 mmol). The resultant mixture was heated under reflux for 24 h to give a deep purple solution with a pale green precipitate. The precipitate was filtered and then washed with hot methanol, cold methanol, and diethyl ether. The rhenium(V) oxo complex was isolated as a pale green solid. Yield: 14.8 mg (41%). Mp>276° C. (gradual darkening and decomposition). ¹H NMR (400 MHz, DMSO-d6): δ 9.69 (s, 2H), 8.60 (s, 2H), 2.99 (s, 6H), 2.74 (s, 6H), 2.36 (s, 3H). IR (KBr, cm⁻¹): 954.85 (Re═O), 492.85 (Re—OMe). ESI-MS (MeOH/DMSO): m/z 509.0 ([M-OMe]⁺, calcd 509.0). Anal. Calcd for 2, C₁₇H₁₉Cl₂N₂O₂Re: C, 37.78; H, 3.54; N, 5.18. Found: C, 37.76; H, 3.63; N, 4.99.

Cytotoxicity MTT Assay.

The colorimetric MTT assay was used to determine the toxicity of 1, 2, and cisplatin. Cells (2×10³ cells/well) were seeded in a 96-well plate. After the cells were incubated overnight, various concentrations of 1, 2, and cisplatin (0.3-100 μM) were added and incubated for 72 h (total volume 200 μL). Cisplatin was prepared as a 5 mM solution in phosphate-buffered saline (PBS) and diluted using media. 1 and 2 were prepared as 10 mM solutions in DMSO and diluted using media. The final concentration of DMSO in each well was 0.5%, and this amount was also present in the untreated control. After 72 h, the medium was removed, 200 μL of a 0.4 mg/mL solution of MTT in DMEM, RPMI, or McCoy's 5A was added, and the plate was incubated for an additional 1-2 h. The DMEM/MTT, RPMI/MTT, or McCoy's 5A/MTT mixture was aspirated, and 200 μL of DMSO was added to dissolve the resulting purple formazan crystals. The absorbance of the solution wells was read at 550 nm. Absorbance values were normalized to DMSO-containing control wells and plotted as the concentration of test compound versus % cell viability. IC₅₀ values were interpolated from the resulting dose-dependent curves. The reported IC₅₀ values are the average from at least three independent experiments, each of which consisted of six replicates per concentration level.

For specific cell death inhibitor assays, inhibitors of necroptosis (necrostatin-1, 60 μM), H₂O₂-induced necrosis (IM-54, 10 μM), and apoptosis (v-VAD-FMK, 5 μM) were added to cells and incubated for 1 h prior to treatment with the test compounds. Reactivity of 1 and 2 with Necrostatin-1. Mixing the rhenium(V) oxo complexes 1 and 2 (20 μM) with necrostatin-1 (60 μM) in DMSO and cell culture media (DMEM, RPMI, and McCoy's 5A) did not result in a precipitate. Incubation of the rhenium(V) oxo complexes 1 and 2 with necrostatin-1 (1:3 ratio) for up to 6 h in DMSO-d₆ did not lead to a chemical reaction, as determined by ¹H NMR analysis. Despite the presence of sulfur and nitrogen atoms in necrostatin-1, the 1H NMR spectra unequivocally prove that the reactivity/bioactivity of 1 and 2 is not compromised by necrostatin-1.

Intracellular ROS Assay.

Untreated and treated A549 cells (1.5×10⁶ cells/well) grown in six-well plates were incubated with 6-carboxy-2′,7′-dichlorodihydrofluorescein diacetate (20 μM) for 30 min. The cells were then washed with PBS (1 mL×3), harvested, and analyzed by using a FACSCalibur-HTS flow cytometer (BD Biosciences) (20 000 events per sample were acquired). The FL1 channel was used to assess intracellular ROS levels. Cell populations were analyzed using the FlowJo software (Tree Star).

JC-1 Assay.

The JC-1 Mitochondrial Membrane Potential Assay Kit (Cayman) was used. The manufacturer's protocol was followed to carry out this experiment. Briefly, to untreated and treated A549 cells (1.5×10⁶ cells/well) grown in six-well plates was added the JC-1 staining solution (100 μL/mL of cell media). The cells were incubated for 30 min, harvested, and analyzed by using the FACSCalibur-HTS flow cytometer (BD Biosciences) (20 000 events per sample were acquired). The FL1 channel was used to assess mitochondrial depolarization. Cell populations were analyzed using the FlowJo software (Tree Star).

Propidium Iodide Uptake.

Untreated and treated A549 cells (1.5×10⁶ cells/well) grown in six-well plates were washed with PBS (1 mL×3), harvested, incubated with PI (5 μM), and analyzed by using the FACSCalibur-HTS flow cytometer (BD Biosciences) (20 000 events per sample were acquired). The FL2 channel was used to assess intracellular PI uptake. Cell populations were analyzed using the FlowJo software (Tree Star).

Fluorescence Microscopy.

A549 cells (1.5×10⁶ cells/well) were incubated with and without 1 and 2 (20 μM) for 12 h. The media were then removed, and the cells were washed with additional media (2 mL×2). After incubation of the cells with more media containing Hoechst 33258 (7.5 μM) and PI (5 μM), the nuclear regions were imaged using a fluorescence microscope. Fluorescence imaging experiments were performed using a Zeiss Axiovert 200M inverted epifluorscence microscope with a Hamamatsu EM-CCD digital camera C9100 and a MS200 XY Piezo Z stage (Applied Scientific Instruments, Inc.). An X-Cite 120 metal halide lamp (EXFO) was used as the light source. Zeiss standard filter set 49 was employed for imaging the nuclear region. The microscope was operated with Volocity software (version 6.01, Improvision). The exposure time for acquisition of fluorescence images was kept constant for each series of images at each channel.

Immunoblotting Analysis.

A549 cells (1.5×10⁶ cells/well) grown in six-well plates were incubated with 1 and 2 (concentrations, sub-μM) for 72 h at 37° C. Cells were washed with PBS, scraped into SDS-PAGE loading buffer (64 mM Tris-HCl (pH 6.8)/9.6% glycerol/2% SDS/5% f-mercaptoethanol/0.01% Bromophenol Blue), and incubated at 95° C. for 10 min. Whole cell lysates were resolved by 4-20% sodium dodecyl sulfate polyacylamide gel electrophoresis (SDS-PAGE; 200 V for 25 min), followed by electro-transfer to polyvinylidene difluoride membrane (350 mA for 1 h). Membranes were blocked in 5% (w/v) non-fat milk in PBST (PBS/0.1% Tween 20) and incubated with the appropriate primary antibodies (Cell Signalling Technology and Santa Cruz). After incubation with horseradish peroxidase-conjugated secondary antibodies (Cell Signalling Technology), immuno complexes were detected with the ECL detection reagent (BioRad) and analyzed using an Alpha Innotech Chemilmager 5500 instrument fitted with a chemiluminescence filter.

Cell Cycle.

In order to monitor the cell cycle, flow cytometry studies were carried out. A549 cells (1.5×10⁶ cells/well) grown in six-well plates were incubated with and without the test compounds for 24, 48, and 72 h at 37° C. Cells were harvested from adherent cultures by trypsinization and combined with all detached cells from the incubation medium to assess total cell viability. Following centrifugation at 1000 rpm for 5 min, cells were washed with PBS and then fixed with 70% ethanol in PBS. Fixed cells were collected by centrifugation at 2500 rpm for 3 min, washed with PBS, and centrifuged as before. Cellular pellets were resuspended in 50 μg/mL PI (Sigma) in PBS for nucleic acids staining and treated with 100 μg/mL RNaseA (Sigma). DNA content was measured on a FACSCalibur-HTS flow cytometer (BD Biosciences) using laser excitation at 488 nm, and 20 000 events per sample were acquired. Cell cycle profiles were analyzed using the ModFit software.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A compound comprising Formula (I): 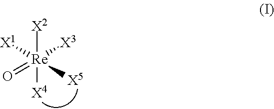
wherein: 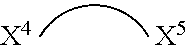
is a bidentate ligand and X⁴ and X⁵ are the same or different and are selected from the group consisting of N, O, S, and P;
X¹, X², and X³ are the same or different and are selected from the group consisting of optionally substituted alkyl, optionally substituted heteroalkyl, halo, —CN, —OR′, —SR′, —SCN, —OCOR′, —OSO₂, and —OPO₃R′₂; and
each R′ is independently hydrogen, optionally substituted alkyl, optionally substituted heteroalkyl, optionally substituted aryl, or optional substituted heteroaryl.

2. The compound of claim 1, wherein X⁴ and X⁵ are N.

3. The compound of claim 1, wherein X⁴ and X⁵ are O.

4. The compound of claim 1, wherein X⁴ and X⁵ are S.

5. The compound of claim 1, wherein X⁴ and X⁵ are P.

6. The compound of claim 1, wherein 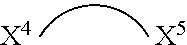
comprises the structure: 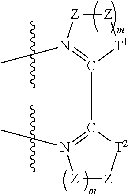
wherein:
each Z is independently —NR″—, —CR″═, —CR″₂—, —O—, or —S—;
T¹ and T² are independently —NR″—, —CR″═, —CR″₂—, —O—, or —S—, or optionally, T¹ and T² may be joined together to form a ring;
each R″ is independently hydrogen, optionally substituted alkyl, optionally substituted heteroalkyl, optionally substituted alkenyl, optionally substituted alkynyl, optionally substituted aryl, or optionally substituted heteroaryl, or optionally, any two R″ may be joined to form a ring; and
each m is independently 1 or 2.

7. The compound of claim 1, wherein X⁴ and X⁵ are N and 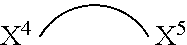
comprises the structure: 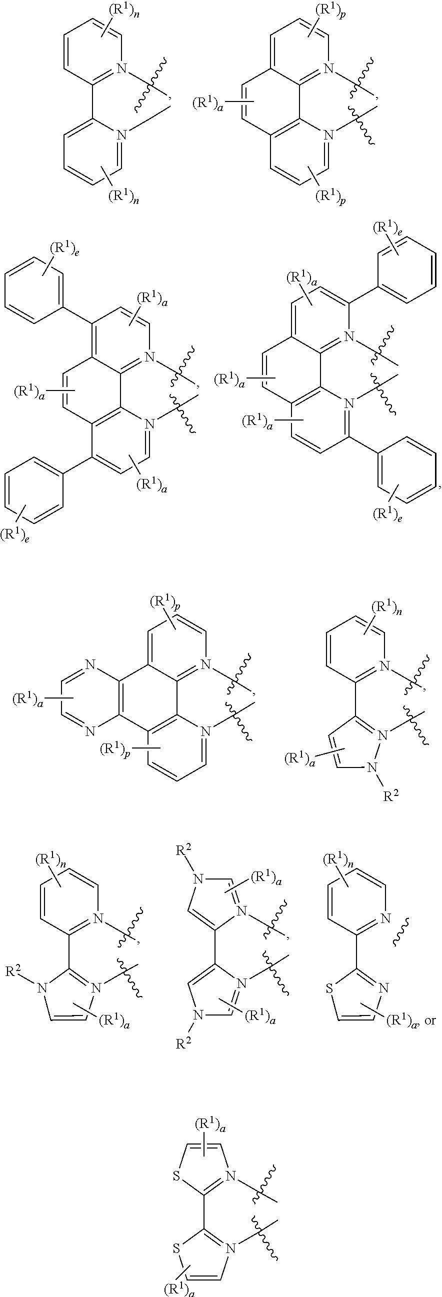
wherein:
each R¹ is independently —CN, —OR³, —SR³, —COOR³, —OCOR³, —N(R³)₂, —NO₂, halo, optionally substituted alkyl, optionally substituted heteroalkyl, optionally substituted cycloheteroalkyl, optionally substituted alkenyl, optionally substituted alkynyl, optionally substituted aryl, or optionally substituted heteroaryl, or optionally any two R¹ may be joined to form a ring;
each R² is independently hydrogen, optionally substituted alkyl, optionally substituted heteroalkyl, optionally substituted aryl, optional substituted heteroaryl, or optionally substituted alkoxy;
each R³ is independently hydrogen, optionally substituted alkyl, optionally substituted heteroalkyl, optionally substituted aryl, or optional substituted heteroaryl;
each e is independently 0, 1, 2, 3, 4, or 5;
each n is independently 0, 1, 2, 3, or 4;
each p is independently 0, 1, 2, or 3; and
each a is independently 0, 1, or 2.

8. The compound of claim 1, wherein X¹ and X² are halo.

9. The compound of claim 1, wherein X¹ and X² are chloro.

10. The compound of claim 1, wherein X³ is OR′.

11. The compound of claim 1, wherein R′ is optionally substituted alkyl.

12. A pharmaceutical composition, comprising:
a compound of claim 1, or a pharmaceutically acceptable salt thereof; and
one or more pharmaceutically acceptable carriers, additives, and/or diluents.

13. A kit for the treatment of cancer, comprising:
a compound of claim 1; and
instructions for use of the composition for treatment of cancer.

14. A method of treating cancer in a patient in need of treatment for cancer, comprising:
administering a compound of claim 1 to the patient.
